(19) United States
(12) Patent Application Publication
(10) Pub. No.: US 2010/0009207 A1
(43) Pub. Date: Jan. 14, 2010

(54) FORMABLE THERMOPLASTIC MULTI-LAYER ARTICLE, A FORMED MULTI-LAYER ARTICLE, AN ARTICLE, AND A METHOD OF MAKING AN ARTICLE

(75) Inventors: Naveen Agarwal, Jacksonville, FL (US); Himanshu Asthana, Evansville, IN (US); Rupali Ramesh Davda, Evansville, IN (US); James L. DeRudder, Mt. Vernon, IN (US)

Correspondence Address: CANTOR COLBURN, LLP, 20 Church Street, 22nd Floor, Hartford, CT, 06103, US

(73) Assignee: SABIC INNOVATIVE PLASTICS IP B.V., Bergen op Zoom (NL)

(21) Appl. No.: 12/170,796

(22) Filed: Jul. 10, 2008

(51) Int. Cl. B32B 27/08; B29C 47/06

(52) U.S. Cl. 428/483; 428/500; 264/241

(57) ABSTRACT

Disclosed is a formable thermoplastic multi-layer article comprising an outer layer comprising a polymer comprising resorcinol arylate polyester chain members, a middle layer comprising a thermoplastic polymer, an inner tie-layer comprising a thermoplastic polymer comprising a carbonate polymer and bulk polymerized acrylonitrile-butadiene-styrene (ABS), the middle layer being between the outer layer and the inner tie-layer and being in contact with both the outer layer and the inner tie-layer. Also disclosed is a thermoformed multi-layer article. A method of making the article is also disclosed.

### BACKGROUND OF THE INVENTION

Many automobile components and vehicle body panels are molded of thermoformable compositions such as thermosetting polymer compositions. However, the automotive industry generally requires that all surfaces visible to the consumer have ‘Class A’ surface quality. At a minimum, such surfaces must be smooth, glossy, and weatherable. Components made of thermoformable compositions often require extensive surface preparation and the application of a curable coating to provide a surface of acceptable quality and appearance. The steps required to prepare such a surface may be expensive and time consuming and may affect the mechanical properties of the thermoset materials.

Although the as-molded surface quality of thermoformable components continues to improve, imperfections in their surfaces due to exposed glass fibers, glass fiber read-through, and the like often occur. These surface imperfections may further result in imperfections in coatings applied to such surfaces. Defects in the surface of thermoformable compositions and in cured coatings applied to the surfaces of thermoformable compositions may manifest as paint popping, long and short-term waviness, orange peel, variations in gloss, or the like.

Several techniques have been proposed to provide thermoformable surfaces of acceptable appearance and quality. For example, overmolding of thin, preformed paint films may provide a desired Class A surface. However, such overmolding is usually applicable only for those compositions capable of providing virgin molded surfaces that do not require any secondary surface preparation operations. Although ‘as-molded’ surface quality has improved, as-molded surfaces of component parts continue to need sanding, especially at the edges, followed by sealing and priming prior to painting.

In-mold coating can obviate these operations, but only at the cost of greatly increased cycle time and cost. Such processes use expensive paint systems that may be applied to the part surface while the mold is re-opened slightly, and then closed to distribute and cure the coating.

Surface improvements have also been obtained by the addition of low profile additives. Such additives reduce the “read-through” at the surface by causing minute internal voids due to the high stresses and provide a smoother surface. If the void occurs at the surface however, a defect may result in the finish. The voids also act as stress concentrators, which may cause premature failures under additional stress or appear during the general sanding at the surface and leave a pit that the painting process cannot hide.

Multi-layer articles have traditionally been formed in a variety of methods, including co-injecting molding, overmolding, multi-shot injection molding, sheet molding, co-extrusion, placement of a film of coating layer material on the surface of a substrate layer, and the like. Co-extrusion methods are especially desirable. Multi-layer articles formed by co-extrusion are advantageous economically and generally exhibit improvements in cohesion and adhesion relative to the various layers making up the multi-layer article. However, some multi-layer article compositions are difficult to form by co-extrusion. Thus, it has been difficult to provide formable multi-layer articles that have a desirable balance of properties with respect to adhesion to a substrate and surface quality but are also able to be co-extruded.

Therefore, there continues to be a need for a thermoformable multi-layer article composition that more effectively adheres to a substrate surface and provides desirable ‘Class A’ surface quality. Further, there is a need in the art for such thermoformable multi-layer article compositions that can be made by co-extrusion processes. There is also a need for more efficient manufacturing methods of multi-layer article compositions by reducing or eliminating yield losses. In addition, there is a need for the multilayer article to have a defect free inner tie-layer, which after thermoforming results in a Class A surface finish on the first, exterior surface.

### SUMMARY OF INVENTION

Disclosed herein is a formable thermoplastic multi-layer article that comprises an outer layer comprising a polymer comprising resorcinol arylate polyester chain members, a middle layer comprising a thermoplastic polymer, an inner tie-layer comprising a thermoplastic polymer comprising a carbonate polymer and bulk polymerized acrylonitrile-butadiene-styrene, the middle layer being between the outer layer and the inner tie-layer and being in contact with both the outer layer and the inner tie-layer.

Also disclosed is a thermoformed article that comprises an outer layer comprising a polymer comprising resorcinol arylate polyester chain members, a middle layer comprising a thermoplastic polymer, an inner tie-layer comprising a thermoplastic polymer comprising a carbonate polymer and bulk polymerized acrylonitrile butadiene styrene, the middle layer being juxtaposed between the outer layer and the inner tie-layer and being in continuous contact with both the outer layer and the inner tie-layer, wherein less than or equal to 20% of greater than or equal to 100 of the formed articles have surface defects arising from inner tie-layer inclusions greater than or equal to 0.2 mm in diameter.

In one embodiment a method of making a multi-layer article is disclosed that comprises coextruding an outer layer comprising a polymer comprising resorcinol arylate polyester chain members, a middle layer comprising a thermoplastic polymer, and an inner tie-layer comprising a thermoplastic polymer comprising a carbonate polymer and a bulk polymerized acrylonitrile-butadiene-styrene, the middle layer being between the outer layer and the inner tie-layer and being in contact with the both the outer layer and the inner tie-layer.

In another embodiment, a method of making an article is disclosed that comprises placing a multi-layer article into a mold; forming a cavity behind the multi-layer article, wherein the multilayer article comprises an outer layer comprising a polymer comprising resorcinol arylate polyester chain members, a middle layer comprising a thermoplastic polymer, and an inner tie-layer comprising a thermoplastic polymer comprising a carbonate polymer and a bulk polymerized acrylonitrile-butadiene-styrene, the middle layer being between the outer layer and the inner tie-layer and being in contact with the both the outer layer and the inner tie-layer, placing a substrate into the cavity; and bonding the inner tie-layer to the substrate.

### BRIEF DESCRIPTION OF THE DRAWINGS

FIG. 1 is a cross-sectional view of one embodiment of the disclosed multi-layer article.

FIG. 2 is a cross-sectional view of one embodiment of a formed article comprising a multi-layer article of FIG. 1 bonded to a substrate.

FIG. 3 is a schematic view of one embodiment of a co-extrusion mechanism for forming the multi-layer article of the present disclosure.

FIG. 4 is a cross sectional view of one embodiment of the method of making an article.

FIG. 5 is a cross sectional view of one embodiment of the method of making an article.

FIG. 6 is a cross sectional view of one embodiment of the method of making an article.

### DETAILED DESCRIPTION OF THE INVENTION

Thermoformable multi-layer articles provide acceptable adhesion to both the intralayer and interlayer when applied to various automobile components without distorting the quality of the underlying surface or substrate. However, these articles can show surface defects, due to the transfer of defects residing in the inner tie-layer of such multilayer articles. For example, a multilayer article having point defects or inclusions on the tie-layer surface, when thermoformed, may show defects in the form of dents or bumps on the exterior surface, due the to transfer of stresses from defects in the tie-layer to the first outer layer during thermoforming. Thus a multilayer article for use in automotive exterior applications requires not only a Class A exterior surface, but also a relatively defect free inner tie-layer, to allow for the formation of such a multilayer article.

It has been discovered that defects, such as point defects or inclusions in the third layer during manufacturing, can occur when using a polycarbonate acrylonitrile-butadiene-styrene copolymer prepared by an emulsion polymerization technique. Not to be limited by theory, it is believed that defects occur because a polycarbonate acrylonitrile-butadiene-styrene copolymer prepared using emulsion polymerization contains surfactants, volatiles, and residual acids leading to the formation of point defects when the polycarbonate/acrylonitrile butadiene styrene copolymer is extruded in film or sheet applications. The presence of tie layer defects leads to high yield losses when the defects transfer to the first layer surface upon thermoforming.

In one embodiment, a multi-layer article is disclosed having a Class A outer surface, with minimal surface defects both before and after thermoforming, in either a formed multilayer article or in a formed article. In another embodiment, a multilayer article having improved inter-layer adhesion between the middle and inner tie-layer is disclosed.

In one embodiment, a formed multi-layer article is provided. Such formed multi-layer articles may be made by a thermoforming method such as vacuum forming or by a method such as compression forming. In one exemplary embodiment, the formed multi-layer article is formed by thermoforming. The multi-layer article can be adhered to a substrate. In one embodiment, the substrate can be any of a variety of materials including thermosetting materials, thermoplastic materials, foamed materials such as foamed polyurethane materials, and the like. The article is useful for preparing exterior automotive panels. In one embodiment, the multi-layer article bonded to a substrate will be a formed multi-layer article.

In one embodiment, a formable thermoplastic multi-layer article is disclosed that comprises an outer layer comprising a polymer comprising resorcinol arylate polyester chain members, a middle layer comprising a thermoplastic polymer, an inner tie-layer comprising a thermoplastic polymer comprising a carbonate polymer and bulk polymerized acrylonitrile-butadiene-styrene. The middle layer is between the outer layer and the inner tie-layer and is in contact with both the outer layer and the inner tie-layer.

In another embodiment, the inner tie-layer further comprises a styrene acrylonitrile copolymer (SAN).

In yet another embodiment, the inner tie-layer comprises about 25 to about 80 weight % of polycarbonate based on the total weight of the inner tie-layer. In still another embodiment, the inner tie-layer comprises about 10 to about 35 weight % of the bulk polymerized acrylonitrile-butadiene-styrene, the weight % being based on the total weight of the inner tie-layer. In a further embodiment, the inner tie-layer comprises about 0 to about 30 weight % of a rigid styrenic copolymer, based on the total weight of the inner tie-layer.

In one embodiment, the styrenic copolymer is a styrene acrylonitrile copolymer (SAN). In another embodiment, the inner tie-layer comprises a thermoplastic polymer having a melt flow index of about 3 to about 30 cm³/10 min (at 260° C./5 kg). In yet another embodiment, the multi-layer article is formed by co-extrusion of the inner tie-layer, middle layer, and outer layer. In a further embodiment, a substrate is bonded to the inner tie-layer.

In one embodiment adhesion between the middle layer and the inner tie-layer as measured by a 90° peel test is greater than or equal to 701 Newtons per meter, specifically greater than or equal to 1051 Newtons per meter, more specifically greater than or equal to 1401 Newtons per meter.

In another embodiment, less than or equal to 20%, specifically less than or equal to 10%, more specifically less than or equal to 5%, even more specifically less than or equal to 2% of the articles have inner tie-layer inclusion defects greater than or equal to 0.2 mm in diameter.

In one embodiment a thermoformed article is disclosed that comprises an outer layer comprising a polymer comprising resorcinol arylate polyester chain members, a middle layer comprising a thermoplastic polymer, an inner tie-layer comprising a thermoplastic polymer comprising a carbonate polymer and bulk polymerized acrylonitrile butadiene styrene. The middle layer is juxtaposed between the outer layer and the inner tie-layer and is in continuous contact with both the outer layer and the inner tie-layer. Less than or equal to 20% of greater than or equal to 100 of the formed articles have surface defects arising from tie-layer inclusion defects greater than or equal to 0.2 mm in diameter.

In another embodiment, less than or equal to 10%, specifically less than or equal to 5%, more specifically less than or equal to 2% of greater than or equal to 100 of the formed articles have surface defects arising from tie-layer inclusion defects greater than or equal to 0.2 mm in diameter.

In yet another embodiment, a method of making a multi-layer article is disclosed that comprises coextruding an outer layer comprising a polymer comprising resorcinol arylate polyester chain members, a middle layer comprising a thermoplastic polymer, and an inner tie-layer comprising a thermoplastic polymer comprising a carbonate polymer and a bulk polymerized acrylonitrile-butadiene-styrene. The middle layer is between the outer layer and the inner tie-layer and is in contact with both the outer layer and the inner tie-layer.

In still another embodiment, a method of making an article is disclosed that comprises placing a multi-layer article into a mold, forming a cavity behind the multi-layer article, placing a substrate into the cavity, and bonding the inner tie-layer to the substrate. The multilayer article comprises an outer layer comprising a polymer comprising resorcinol arylate polyester chain members, a middle layer comprising a thermoplastic polymer, and an inner tie-layer comprising a thermoplastic polymer comprising a carbonate polymer and a bulk polymerized acrylonitrile-butadiene-styrene. The middle layer is between the outer layer and the inner tie-layer and is in contact with the both the outer layer and the inner tie-layer.

In one embodiment, the multilayer article is formed by coextruding the outer layer, the middle layer, and the inner tie-layer.

As used herein, the term “Class A surface” is given the general meaning known in the art and refers to a surface substantially free of visible defects such as hair-lines, pin-holes and the like. In one embodiment, a Class A surface comprises a gloss of greater than 90 units at either 20 degrees or 60 degrees, a wavescan of less than 5 units (long as well as short), and a distinctness of image (DOI) of greater than 95 units. Upon application to a substrate, the multi-layer article maintains the surface quality of the substrate and provides an article having a desirable surface appearance and quality.

In one embodiment, the outer, middle, and inner tie-layers of the multi-layer article are comprised of thermally stable materials having viscosities and molecular weights such that the individual layers may be co-extruded into a thermoformable multi-layer article. Typically, compositions suitable for extrusion processing have higher weight average molecular weights, higher melt strength, and higher viscosity than compositions intended for processing via injection-molding equipment.

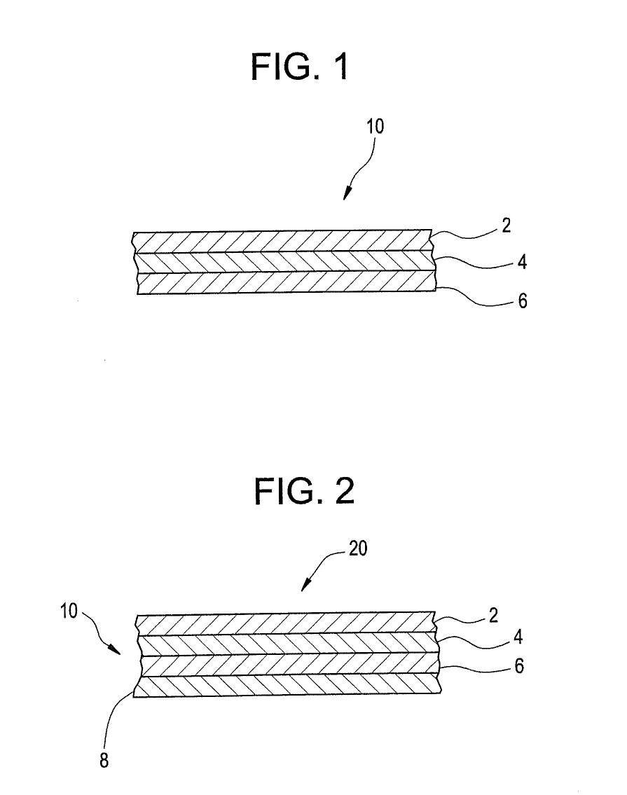

Turning now to FIG. 1, a sectional view of the disclosed multi-layer article 10 is shown. The multi-layer article 10 comprises an outer layer 2, an inner tie-layer 6 opposite to the outer layer 2 and a middle layer 4 disposed between the outer layer 2 and inner tie-layer 6.

In one exemplary embodiment, the outer layer 2 comprises a polymer comprising resorcinol polyester chain members, the middle layer 4 comprises a thermoplastic polymer comprising a carbonate polymer and the tie-layer 6 (also referred to herein as the “inner tie-layer”) comprises a thermoplastic polymer comprising a carbonate polymer and a bulk polymerized acrylonitrile-butadiene-styrene graft copolymer blend. The tie-layer 6 can optionally comprise a rigid styrenic copolymer.

In one embodiment, the outer layer 2 of the multi-layer article 10 will comprise at least one polymer comprising resorcinol arylate polyester chain members.

“Resorcinol arylate polyester chain members” as used herein refers to chain members that comprise at least one diphenol residue in combination with at least one aromatic diphenol residue in combination with at least one aromatic dicarboxylic acid residue. An exemplary diphenol residue, illustrated in Formula I, is derived from a 1,3 dihydroxybenzene moiety, commonly referred to throughout this specification as resorcinol or rescorcinol moiety. Resorcinol or resorcinol moiety as used herein should be understood to include both unsubstituted 1,3-dihydroxybenzene and substituted 1,3-dihydroxybenzene unless explicitly stated otherwise.

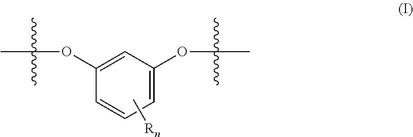

wherein R is at least one of C₁₋₁₂ alkyl or halogen, and n is 0-3.

Exemplary dicarboxylic acid residues include aromatic dicarboylic acid residues derived from monocyclic moieties, specifically isophthalic acid, terephthalic acid, or combinations comprising at least one of the foregoing, or from polycyclic moieties, including diphenyl dicarbonxylic acid, diphenyl ether dicarboxylic acid, naphthalenedicarboxylic acid such as naphthalene-2,6-dicarboxylic acid, and morphthalene dicarbonxylic acid such as morphthalene 2,6-dicarbonxylic acid. In one embodiment, the dicarboxylic acid residue used will be 1,4-cyclohexanedicarboxylic acid residue.

In one exemplary embodiment, the aromatic dicarboxylic acid residues will be derived from mixtures of isophthalic and/or terephthalic acids as illustrated in Formula II.

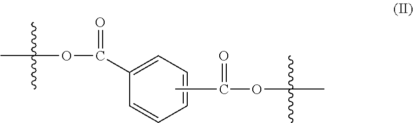

In one exemplary embodiment, the outer layer 2 will comprise a polymer as illustrated in Formula III wherein R and n are as previously defined:

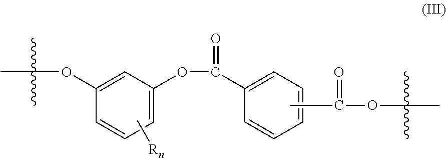

In one exemplary embodiment, the outer layer 2 will comprise a polymer having resorcinol arylate polyester chain members that are substantially free of anhydride linkages as are illustrated in Formula IV:

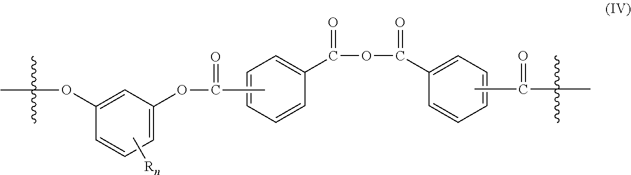

In one exemplary embodiment, outer layer 2 will comprise a polymer comprising resorcinol arylate polyester chain members made by an interfacial method comprising a first step of combining at least one resorcinol moiety and at least one catalyst in a mixture of water and at least one organic solvent substantially immiscible with water. Exemplary resorcinol moieties comprise units of Formula V:

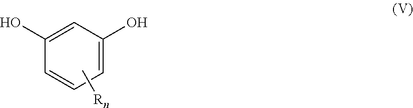

wherein R is at least one of C₁₋₁₂ alkyl or halogen, and n is 0-3. Alkyl groups, if present, are specifically straight chain or branched alkyl groups, and are most often located in the ortho position to both oxygen atoms although other ring locations are contemplated. Exemplary C₁₋₁₂ alkyl groups include methyl, ethyl, n-propyl, isopropyl, butyl, iso-butyl, t-butyl, nonyl, decyl, and aryl-substituted alkyl, including benzyl, with methyl being particularly exemplary. Exemplary halogen groups are bromo, chloro, and fluoro. The value for n may be 0-3, specifically 0-2, and more specifically 0-1. An exemplary resorcinol moiety is 2-methylresorcinol. Another exemplary resorcinol moiety is an unsubstituted resorcinol moiety in which n is zero.

In one exemplary embodiment, at least one catalyst will be combined with the reaction mixture used in the interfacial method of polymerization. Said catalyst may be present at a total level of 0.1 to 10 mole %, and specifically 0.2 to 6 mole % based on total molar amount of acid chloride groups. Exemplary catalysts comprise tertiary amines, quaternary ammonium salts, quaternary phosphonium salts, hexaalkylguanidinium salts, and mixtures thereof. Exemplary tertiary amines include triethylamine, dimethylbutylamine, diisopropylethylamine, 2,2,6,6-tetramethylpiperidine, and combinations comprising at least one of the foregoing. Other contemplated tertiary amines include N—C₁-C₆-alkyl-pyrrolidines, such as N-ethylpyrrolidine, N—C₁-C₆-piperidines, such as N-ethylpiperidine, N-methylpiperidine, and N-isopropylpiperidine, N—C₁-C₆-morpholines, such as N-ethylmorpholine and N-isopropyl-morpholine, N—C₁-C₆-dihydroindoles, N—C₁-C₆-dihydroisoindoles, N—C₁-C₆-tetrahydroquinolines, N—C₁-C₆-tetrahydroisoquinolines, N—C₁-C₆-benzo-morpholines, 1-azabicyclo-[3.3.0]-octane, quinuclidine, N—C₁-C₆-alkyl-2-azabicyclo-[2.2.1]-octanes, N—C₁-C₆-alkyl-2-azabicyclo-[3.3.1]-nonanes, and N—C₁-C₆-alkyl-3-azabicyclo-[3.3.1]-nonanes, N,N,N′,N′-tetraalkylalkylene-diamines, including N,N,N′,N′-tetraethyl-1,6-hexanediamine. Exemplary tertiary amines are triethylamine and N-ethylpiperidine.

When the catalyst consists of at least one tertiary amine alone, then said catalyst may be present at a total level of 0.1 to 10 mole percent (mole %), specifically 0.2 to 6 mole %, more specifically 1 to 4 mole %, and even more specifically 2.5 to 4 mole % based on total molar amount of acid chloride groups. In one embodiment of the invention all of the at least one tertiary amine is present at the beginning of the reaction before addition of dicarboxylic acid dichloride to resorcinol moiety. In another embodiment a portion of any tertiary amine is present at the beginning of the reaction and a portion is added following or during addition of dicarboxylic acid dichloride to resorcinol moiety. In this latter embodiment the amount of any tertiary amine initially present with resorcinol moiety of about 0.005 wt. % to about 10 wt. %, specifically, about 0.01 to about 1 wt. %, and more specifically, about 0.02 to about 0.3 wt. % based on total amine.

Exemplary quaternary ammonium salts, quaternary phosphonium salts, and hexaalkylguanidinium salts include halide salts such as tetraethylammonium bromide, tetraethylammonium chloride, tetrapropylammonium bromide, tetrapropylammonium chloride, tetrabutylammonium bromide, tetrabutylammonium chloride, methyltributylammonium chloride, benzyltributylammonium chloride, benzyltriethylammonium chloride, benzyltrimethylammonium chloride, trioctylmethylammonium chloride, cetyldimethylbenzylammonium chloride, octyltriethylammonium bromide, decyltriethylammonium bromide, lauryltriethylammonium bromide, cetyltrimethylammonium bromide, cetyltriethylammonium bromide, N-laurylpyridinium chloride, N-laurylpyridinium bromide, N-heptylpyridinium bromide, tiicaprylylmethylammonium chloride (sometimes known as ALIQUAT 336), methyltri-C₈-C₁₀-alkyl-ammonium chloride (sometimes known as ADOGEN 464), N,N,N′,N′,N′-pentaalkyl-alpha, omega-amineammonium salts such as disclosed in U.S. Pat. No. 5,821,322; tetrabutylphosphonium bromide, benzyltriphenylphosphonium chloride, triethyloctadecylphosphonium bromide, tetraphenylphosphonium bromide, triphenylmethylphosphonium bromide, trioctylethylphosphonium bromide, cetyltriethylphosphonium bromide, hexaalkylguanidinium halides, hexaethylguanidinium chloride, and the like, and combinations comprising at least one of the foregoing.

Organic solvents substantially immiscible with water include those that are less than about 5 wt. %, and specifically less than about 2 wt. % soluble in water under the reaction conditions. Exemplary organic solvents include dichloromethane, trichloroethylene, tetrachloroethane, chloroform, 1,2-dichloroethane, toluene, xylene, trimethylbenzene, chlorobenzene, o-dichlorobenzene, and combinations comprising at least one of the foregoing. An exemplary solvent is dichloromethane.

Exemplary dicarboxylic acid dichlorides comprise aromatic dicarboxylic acid dichlorides derived from monocyclic moieties, specifically isophthaloyl dichloride, terephthaloyl dichloride, or mixtures of isophthaloyl and terephthaloyl dichlorides, or from polycyclic moieties, including diphenyl dicarboxylic acid dichloride, diphenylether dicarboxylic acid dichloride, and naphthalenedicarboxylic acid dichloride, specifically naphthalene-2,6-dicarboxylic acid dichloride; or from mixtures of monocyclic and polycyclic aromatic dicarboxylic acid dichlorides. Specifically, the dicarboxylic acid dichloride comprises mixtures of isophthaloyl and/or terephthaloyl dichlorides as typically illustrated in Formula VI.

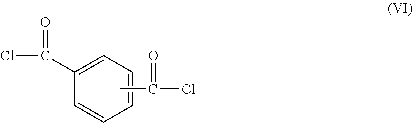

Either or both of isophthaloyl and terephthaloyl dichlorides may be used to make the polymer comprised in the outer layer 2. In one embodiment, the dicarboxylic acid dichlorides comprise mixtures of isophthaloyl and terephthaloyl dichloride in a molar ratio of isophthaloyl to terephthaloyl of about 0.25-4.0:1, in another embodiment, about 0.4-2.5:1, and in one exemplary embodiment, about 0.67-1.5:1.

The pH of the interfacial reaction mixture is maintained between about 3 and about 8.5 in one embodiment, and between about 5 and about 8 in another embodiment, throughout addition of the at least one dicarboxylic acid dichloride to the at least one resorcinol moiety. Exemplary reagents to maintain the pH include alkali metal hydroxides, alkaline earth hydroxides, and alkaline earth oxides. Exemplary reagents are potassium hydroxide and sodium hydroxide. A particularly exemplary reagent is sodium hydroxide. The reagent to maintain pH may be included in the reaction mixture in any convenient form. In one embodiment, the reagent is added to the reaction mixture as an aqueous solution simultaneously with the at least one dicarboxylic acid dichloride.

The temperature of the interfacial reaction mixture may be any convenient temperature that provides a rapid reaction rate and a resorcinol arylate-containing polymer substantially free of anhydride linkages. Convenient temperatures include about −20° C. to the boiling point of the water-organic solvent mixture under the reaction conditions. In one embodiment, the reaction is performed at the boiling point of the organic solvent in the water-organic solvent mixture. In one exemplary embodiment the reaction is performed at the boiling point of dichloromethane.

The total molar amount of acid chloride groups added to the reaction mixture is stoichiometrically deficient relative to the total molar amount of phenolic groups. Said stoichiometric ratio is desirable so that hydrolysis of acid chloride groups is minimized, and so that nucleophiles such as phenolic and/or phenoxide may be present to destroy any adventitious anhydride linkages, should any form under the reaction conditions. The total molar amount of acid chloride groups includes at least one dicarboxylic acid dichloride, and any mono-carboxylic acid chloride chain-stoppers and any tri- or tetra-carboxylic acid tri- or tetra-chloride branching agents which may be used. The total molar amount of phenolic groups includes resorcinol moieties, and any mono-phenolic chain-stoppers and any tri- or tetra-phenolic branching agents that may be used. The stoichiometric ratio of total phenolic groups to total acid chloride groups is specifically about 1.5-1.01:1 and more specifically about 1.2-1.02:1.

The presence or absence of anhydride linkages following complete addition of the at least one dicarboxylic acid dichloride to the at least one resorcinol moiety will typically depend upon the exact stoichiometric ratio of reactants and the amount of catalyst present, as well as other variables. For example, if a sufficient molar excess of total phenolic groups is present, anhydride linkages are often found to be absent. Often a molar excess of at least about 1%, and in one embodiment, at least about 3%, of total amount of phenolic groups over total amount of acid chloride groups may suffice to eliminate anhydride linkages under the reaction conditions. When anhydride linkages may be present, it is often desirable that the final pH be greater than 7 so that nucleophiles such as phenolic, phenoxide and/or hydroxide may be present to destroy any anhydride linkages. Therefore, in one embodiment, the interfacial method used to provide the polymer of the at least one sub-layer of the outer layer 2 may further comprise the step of adjusting the pH of the reaction mixture to between 7 and 12, in one embodiment, between 8 and 12, and in another embodiment, between 8.5 and 12, following complete addition of the at least one dicarboxylic acid dichloride to the at least one resorcinol moiety. The pH may be adjusted by any convenient method, specifically using an aqueous base such as aqueous sodium hydroxide.

Provided the final pH of the reaction mixture is greater than 7, the interfacial method used to provide the polymer comprised in outer layer 2 may further comprise the step of stirring the reaction mixture for a time sufficient to destroy completely any adventitious anhydride linkages, should any be present. The necessary stirring time will depend upon reactor configuration, stirrer geometry, stirring rate, temperature, total solvent volume, organic solvent volume, anhydride concentration, pH, and other factors. In some instances the necessary stirring time is essentially instantaneous, for example within seconds of pH adjustment to above 7, assuming any adventitious anhydride linkages were present to begin with. For typical laboratory scale reaction equipment a stirring time of at least about 3 minutes, and in one embodiment, at least about 5 minutes may be required. By this process nucleophiles, such as phenolic, phenoxide and/or hydroxide, may have time to destroy completely any anhydride linkages, should any be present.

A chain-stopper (also referred to sometimes hereinafter as capping agent) may also be used in the interfacial method used to make the polymer comprising resorcinol arylate polyester chain members. A purpose of adding a chain-stopper is to limit the molecular weight of polymer comprising resorcinol arylate polyester chain members, thus providing polymer with controlled molecular weight and favorable processability. Typically, a chain-stopper is added when the resorcinol arylate-containing polymer is not required to have reactive end-groups for further application. In the absence of a chain-stopper, resorcinol arylate-containing polymer may be either used in solution or recovered from solution for subsequent use such as in copolymer formation, which may require the presence of reactive end-groups, typically hydroxy, on the resorcinol-arylate polyester segments. A chain-stopper may be at least one of mono-phenolic compounds, mono-carboxylic acid chlorides, and/or mono-chloroformates. Typically, a chain-stopper may be present in quantities of 0.05 to 10 mole %, based on resorcinol moieties in the case of mono-phenolic compounds and based on acid dichlorides in the case mono-carboxylic acid chlorides and/or mono-chloroformates.

Exemplary mono-phenolic compounds include monocyclic phenols, such as phenol, C₁-C₂₂ alkyl-substituted phenols, p-cumyl-phenol, p-tertiary-butyl phenol, hydroxy diphenyl; monoethers of diphenols, such as p-methoxyphenol. Alkyl-substituted phenols include those with branched chain alkyl substituents having 8 to 9 carbon atoms, in one embodiment, in which about 47 to 89% of the hydrogen atoms are part of methyl groups. For some embodiments a mono-phenolic UV screener as capping agent is employed. Such compounds include 4-substituted-2-hydroxybenzophenones and their derivatives, aryl salicylates, monoesters of diphenols, such as resorcinol monobenzoate, 2-(2-hydroxyaryl)-benzotriazoles and their derivatives, 2-(2-hydroxyaryl)-1,3,5-triazines and their derivatives, and like compounds. In one embodiment the mono-phenolic chain-stoppers will be at least one of phenol, p-cumylphenol, or resorcinol monobenzoate.

Exemplary monocarboxylic acid chlorides include monocyclic, monocarboxylic acid chlorides, such as benzoyl chloride, C₁-C₂₂ alkyl-substituted benzoyl chloride, toluoyl chloride, halogen-substituted benzoyl chloride, bromobenzoyl chloride, cinnamoyl chloride, 4-nadimidobenzoyl chloride, and combinations comprising at least one of the foregoing; polycyclic, monocarboxylic acid chlorides, such as trimellitic anhydride chloride, and naphthoyl chloride; and mixtures of monocyclic and polycyclic monocarboxylic acid chlorides. The chlorides of aliphatic monocarboxylic acids with up to 22 carbon atoms and/or functionalized chlorides of aliphatic monocarboxylic acids, such as acryloyl chloride and methacryoyl chloride, may also be possible. Exemplary mono-chloroformates include monocyclic, mono-chloroformates, such as phenyl chloroformate, alkyl-substituted phenyl chloroformate, p-cumyl phenyl chloroformate, toluene chloroformate, and combinations comprising at least one of the foregoing.

A chain-stopper can be combined together with the resorcinol moieties, can be contained in the solution of dicarboxylic acid dichlorides, or can be added to the reaction mixture after production of a precondensate. If monocarboxylic acid chlorides and/or mono-chloroformates are used as chain-stoppers, they are specifically introduced together with dicarboxylic acid dichlorides. These chain-stoppers can also be added to the reaction mixture at a moment when the chlorides of dicarboxylic acid have already reacted substantially or to completion. If phenolic compounds are used as chain-stoppers, they can be added to the reaction mixture during the reaction, or, more specifically, before the beginning of the reaction between resorcinol moiety and acid chloride moiety. When hydroxy-terminated resorcinol arylate-containing precondensate or oligomers are prepared, the chain-stopper may be absent or only present in small amounts to aid control of oligomer molecular weight.

In another embodiment the interfacial method used to provide the polymer comprising resorcinol arylate polyester chain members may encompass the inclusion of at least one branching agent such as a trifunctional or higher functional carboxylic acid chloride and/or trifunctional or higher functional phenol. Such branching agents, if included, can specifically be used in quantities of 0.005 to 1 mole %, based on dicarboxylic acid dichlorides or resorcinol moieties used, respectively. Exemplary branching agents include, for example, trifunctional or higher carboxylic acid chlorides, such as trimesic acid trichloride, cyanuric acid trichloride, 3,3′,4,4′-benzophenone tetracarboxylic acid tetrachloride, 1,4,5,8-naphthalene tetracarboxylic acid tetrachloride or pyromellitic acid tetrachloride, and trifunctional or higher phenols, such as phloroglucinol, 4,6-dimethyl-2,4,6-tri-(4-hydroxyphenyl)-2-heptene, 4,6-dimethyl-2,4,6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenyl methane, 2,2-bis-[4,4-bis-(4-hydroxyphenyl)-cyclohexyl]-propane, 2,4-bis-(4-hydroxyphenylisopropyl)-phenol, tetra-(4-hydroxyphenyl)-methane, 2,6-bis-(2-hydroxy-5-methylbenzyl)-4-methyl phenol, 2-(4-hydroxyphenyl)-2-(2,4-dihydroxyphenyl)-propane, tetra-(4-[4-hydroxyphenylisopropyl]-phenoxy)-methane, 1,4-bis-[(4,4-dihydroxytriphenyl)methyl]-benzene. Phenolic branching agents may be introduced first with the resorcinol moieties whilst acid chloride branching agents may be introduced together with acid dichlorides.

In one exemplary embodiment, the polymer comprising the resorcinol arylate polyester chain members will be recovered from the interfacial reaction mixture by known recovery methods. Recovery methods may include such steps as acidification of the mixture, for example with phosphorous acid; subjecting the mixture to liquid-liquid phase separation; washing the organic phase with water and/or a dilute acid such as hydrochloric acid or phosphoric acid; precipitating by usual methods such as through treatment with water or anti-solvent precipitation with, for example, methanol, ethanol, and/or isopropanol; isolating the resulting precipitates; and drying to remove residual solvents.

If desired, the resorcinol arylate polymers used in the outer layer 2 may be made by the interfacial method further comprising the addition of a reducing agent. Exemplary reducing agents include, for example, sodium sulfite, sodium gluconate, or a borohydride, such as sodium borohydride. When present, any reducing agents are typically used in quantities of 0.25 to 2 mole %, based on moles of resorcinol moiety.

In one embodiment, the polymers comprising resorcinol arylate polyester chain members will be substantially free of anhydride linkages linking at least two mers of the polyester chain. In a particular embodiment said polyesters comprise dicarboxylic acid residues derived from a mixture of iso- and terephthalic acids as illustrated in Formula VII:

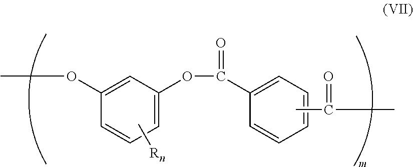

wherein R is at least one of C₁₋₁₂ alkyl or halogen, n is 0-3, and m is at least about 8. In one embodiment, n is zero and m is between about 10 and about 300. The molar ratio of isophthalate to terephthalate is about 0.25-4.0:1, in one embodiment about 0.4-2.5:1, and in another embodiment about 0.67-1.5:1. Substantially free of anhydride linkages means that said polyesters show decrease in molecular weight of less than 30% and specifically less than 10% upon heating said polymer at a temperature of about 280-290° C. for five minutes.

In one embodiment, the polymer comprising resorcinol arylate polyester chain members will comprise copolyesters comprising resorcinol arylate polyester chain members in combination with dicarboxylic acid or diol alkylene chain members (so-called “soft-block” segments), said copolyesters being substantially free of anhydride linkages in the polyester segments. Substantially free of anhydride linkages means that the copolyesters show decrease in molecular weight of less than 10% and specifically less than 5% upon heating said copolyester at a temperature of about 280-290° C. for five minutes.

The term soft-block as used herein indicates that some segments of the polymers are made from non-aromatic monomer units. Such non-aromatic monomer units are generally aliphatic and are known to impart flexibility to the soft-block-containing polymers. The copolymers include those comprising structural units of Formulas I, VIII, and IX:

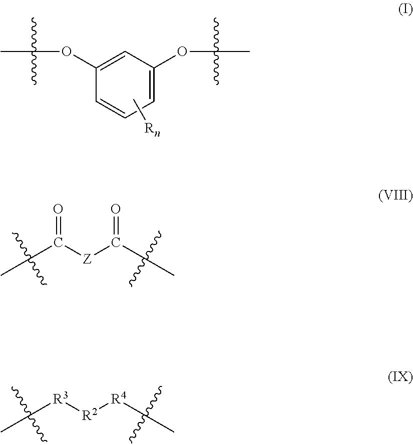

wherein R and n are as previously defined, Z is a divalent aromatic radical, R² is a C₃₋₂₀ straight chain alkylene, C₃₋₁₀ branched alkylene, or C₄₋₁₀ cyclo- or bicycloalkylene group, and R³ and R⁴ each independently represent

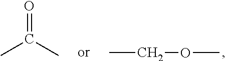

wherein Formula IX contributes about 1 to about 45 mole % to the ester linkages of the polyester. In other embodiments, Formula IX may contribute about 5 to about 40 mole % to the ester linkages of the polyester, specifically, about 5 to about 20 mole %. Another embodiment provides a composition wherein R¹ represents C₃₋₁₄ straight chain alkylene, or C₅₋₆ cycloalkylene, with an exemplary composition being one wherein R² represents C₃₋₁₀ straight-chain alkylene or C₆-cycloalkylene. Formula VIII represents an aromatic dicarboxylic acid residue. The divalent aromatic radical Z in Formula VIII may be derived from at least one of the dicarboxylic acid residues as defined hereinabove, and specifically at least one of 1,3-phenylene, 1,4-phenylene, or 2,6-naphthylene. In exemplary embodiments Z comprises at least about 40 mole percent 1,3-phenylene. In one exemplary embodiment, for copolyesters containing soft-block chain members, n in Formula I is zero.

In one embodiment, the outer layer 2 will comprise copolyesters containing resorcinol arylate chain members comprising about 1 to about 45 mole % sebacate or cyclohexane 1,4-dicarboxylate units. In another embodiment, the copolyester containing resorcinol arylate chain members is one comprising resorcinol isophthalate and resorcinol sebacate units in molar ratio between 8.5:1.5 and 9.5:0.5. In one exemplary embodiment, the copolyester is prepared using sebacoyl chloride in combination with isophthaloyl dichloride.

In another embodiment, the polymer comprising the resorcinol arylate polyester chain members will comprise thermally stable block copolyester carbonates comprising resorcinol arylate-containing block segments in combination with organic carbonate block segments. The segments comprising resorcinol arylate chain members in such copolymers are substantially free of anhydride linkages. Substantially free of anhydride linkages means that the copolyester carbonates show decrease in molecular weight of less than 10% and specifically less than 5% upon heating said copolyester carbonate at a temperature of about 280-290° C. for five minutes.

The block copolyester carbonates include those comprising alternating arylate and organic carbonate blocks, typically as illustrated in Formula X, wherein R and n are as previously defined, and R⁵ is at least one divalent organic radical:

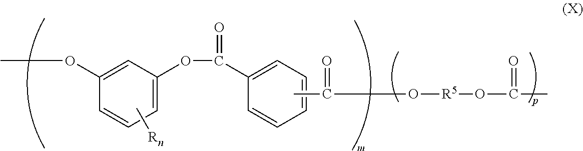

The arylate blocks have a degree of polymerization (DP), represented by m, of at least about 4, specifically at least about 10, more specifically at least about 20 and even more specifically about 30-150. The DP of the organic carbonate blocks, represented by p, is generally at least about 10, specifically at least about 20 and most specifically about 50-200. The distribution of the blocks may be such as to provide a copolymer having any desired weight proportion of arylate blocks in relation to carbonate blocks. In general, the content of arylate blocks is specifically about 10-95% by weight and more specifically about 50-95% by weight.

Although a mixture of iso- and terephthalate is illustrated in Formula X, the dicarboxylic acid residues in the arylate blocks may be derived from one or more various dicarboxylic acid residue(s), as defined hereinabove, including those derived from aliphatic diacid dichlorides (so-called “soft-block” segments). In some embodiments n is zero and the arylate blocks comprise dicarboxylic acid residues derived from a mixture of iso- and terephthalic acid residues, wherein the molar ratio of isophthalate to terephthalate is about 0.25-4.0: 1, specifically, about 0.4-2.5:1, and more specifically, about 0.67-1.5:1.

In the organic carbonate blocks, each R⁵ is independently a divalent organic radical. The radical can comprise at least one dihydroxy-substituted aromatic hydrocarbon, and at least about 60 percent of the total number of R⁵ groups in the polymer are aromatic organic radicals and the balance thereof are aliphatic, alicyclic, or aromatic radicals. Exemplary R⁵ radicals include m-phenylene, p-phenylene, 4,4′-biphenylene, 4,4′-bi(3,5-dimethyl)-phenylene, 2,2-bis(4-phenylene)propane, 6,6′-(3,3,3′,3′-tetramethyl-1,1′-spirobi[1H-indan]) and similar radicals such as those which correspond to the dihydroxy-substituted aromatic hydrocarbons disclosed by name or formula (generic or specific) as described U.S. Pat. No. 4,217,438.

In one exemplary embodiment, each R⁵ is an aromatic organic radical and still more specifically a radical of Formula XI:

-A¹-Y-A²- (XI)

wherein each A¹ and A² is a monocyclic divalent aryl radical and Y is a bridging radical in which one or two carbon atoms separate A¹ and A². The free valence bonds in Formula XI are usually in the meta or para positions of A¹ and A² in relation to Y. Compounds in which R⁵ has Formula XI are bisphenols, and for the sake of brevity the term “bisphenol” is sometimes used herein to designate the dihydroxy-substituted aromatic hydrocarbons. It should be understood, however, that non-bisphenol compounds of this type might also be employed as appropriate.

In Formula XI, A¹ and A² typically represent unsubstituted phenylene or substituted derivatives thereof, illustrative substituents (one or more) being alkyl, alkenyl, and halogen (particularly bromine), specifically unsubstituted phenylene radicals. Both A¹ and A² are specifically p-phenylene, although both may be o- or m-phenylene or one o- or m-phenylene and the other p-phenylene.

The bridging radical, Y, is one in which one or two atoms separate A¹ from A². An exemplary embodiment is one in which one atom separates A¹ from A². Illustrative radicals of this type are —O—, —S—, —SO— or —SO₂—, methylene, cyclohexyl methylene, 2-[2.2.1]-bicycloheptyl methylene, ethylene, isopropylidene, neopentylidene, cyclohexylidene, cyclopentadecylidene, cyclododecylidene, adamantylidene, and like radicals. Specifically, gem-alkylene (commonly known as “alkylidene”) radicals are employed. Also included, however, are unsaturated radicals. For reasons of availability and particular suitability for the purposes of this invention, specifically 2,2-bis(4-hydroxyphenyl)propane (bisphenol-A or BPA), in which Y is isopropylidene and A¹ and A² are each p-phenylene is employed. Depending upon the molar excess of resorcinol moiety present in the reaction mixture, R⁵ in the carbonate blocks may at least partially comprise resorcinol moiety. In other words, in some embodiments, carbonate blocks of Formula X may comprise a resorcinol moiety in combination with at least one other dihydroxy-substituted aromatic hydrocarbon.

Polymers comprising resorcinol arylate polyester chain members further comprise diblock, triblock, and multiblock copolyestercarbonates. The chemical linkages between blocks comprising resorcinol arylate chain members and blocks comprising organic carbonate chain members may comprise at least one of (a) an ester linkage between a suitable dicarboxylic acid residue of an arylate moiety and an —O—R⁵—O— moiety of an organic carbonate moiety, for example as typically illustrated in Formula XII, wherein R is as previously defined:

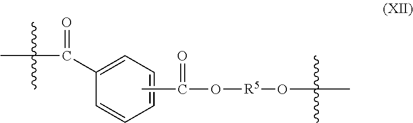

and (b) a carbonate linkage between a diphenol residue of a resorcinol arylate moiety and an organic carbonate moiety as shown in Formula XIII,

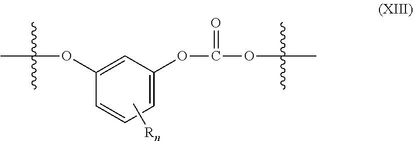

wherein R and n are as previously defined.

The presence of a significant proportion of ester linkages of the type (a) may result in undesirable color formation in the copolyestercarbonates. Although the invention is not limited by theory, it is believed that color may arise, for example, when R⁵ in Formula XII is bisphenol A and the moiety of Formula XII undergoes Fries rearrangement during subsequent processing and/or light-exposure. In one embodiment the copolyester carbonate is substantially comprised of a diblock copolymer with a carbonate linkage between resorcinol arylate block and an organic carbonate block. In one exemplary embodiment, the copolyester carbonate is substantially comprised of a triblock carbonate-ester-carbonate copolymer with carbonate linkages between the resorcinol arylate block and organic carbonate end-blocks.

Copolyestercarbonates with at least one carbonate linkage between a thermally stable resorcinol arylate block and an organic carbonate block are typically prepared from resorcinol arylate-containing oligomers and containing at least one and specifically two hydroxy-terminal sites. Said oligomers typically have weight average molecular weight of about 10,000 to about 40,000, and more specifically about 15,000 to about 30,000. Thermally stable copolyestercarbonates may be prepared by reacting said resorcinol arylate-containing oligomers with phosgene, at least one chain-stopper, and at least one dihydroxy-substituted aromatic hydrocarbon in the presence of a catalyst such as a tertiary amine.

In one exemplary embodiment, the at least one polymer comprising resorcinol arylate polyester chain members comprises an iso terephthalic resorcinol (ITR)/bisphenol A copolymer.

In one embodiment, the outer layer 2 may comprise one or more sub-layers wherein at least one sub-layer comprises the polymer comprising resorcinol acrylate polyester chain members. In one embodiment, the outer layer 2 will consist solely of a single sub-layer comprising the polymer comprising resorcinol acrylate polyester chain members. In another embodiment, the outer layer 2 may comprise one or more additional sub-layers and in one exemplary embodiment, may comprise up to four additional sub-layers. For example, in one embodiment, a sub-layer may be a composition capable of adhering the outer layer 2 to the middle layer 4. Illustrative examples of adhesive compositions include heat sensitive adhesives, pressure sensitive adhesives, and the like.

In one exemplary embodiment the outer-most layer of the outer layer 2 will be at least one sub-layer comprising a polymer comprising resorcinol acrylate polyester chain members. As used herein “outer-most layer” refers to the sub-layer that forms an exterior surface 12 as illustrated in FIG. 1.

The outer layer 2 can comprise other components such art-recognized additives including, but not limited to, stabilizers, color stabilizers, heat stabilizers, light stabilizers, auxiliary UV screeners, auxiliary UV absorbers, flame retardants, anti-drip agents, flow aids, plasticizers, ester interchange inhibitors, antistatic agents, mold release agents, and colorants such as metal flakes, glass flakes and beads, ceramic particles, other polymer particles, dyes and pigments which may be organic, inorganic or organometallic.

In one embodiment, the total thickness of the outer layer 2 is about 0.08 to about 0.64 millimeters (mm). In another embodiment, the outer layer 2 is about 0.08 to about 0.38 mils thick. In one exemplary embodiment, the thickness of the outer layer 2 is about 0.13 to about 0.38 mils.

In one exemplary embodiment, the middle layer 4 of the multi-layer article 10 comprises a thermoplastic polymer comprising a carbonate polymer and is disposed between the outer layer 2 and tie-layer 6. In one embodiment, the middle layer 4 is in contact with both the outer layer 2 and the inner tie-layer 6. In one exemplary embodiment, the middle layer 4 will be in continuous contact with the both the outer layer 2 and the inner tie-layer 6.

The thickness of the middle layer 4 may be determined by the desired application. In one embodiment, the middle layer 4 is about 0.1 to about 5.08 mm thick, while in another embodiment, the middle layer 4 is about 0.13 to 1.27 mm thick. In one exemplary embodiment, the middle layer 4 will be about 0.38 to about 0.76 mm thick.

The thermoplastic polymer of the middle layer may also comprise other thermoplastic polymers in addition to the carbonate polymer. Illustrative examples of other thermoplastic polymers for use in the thermoplastic blend of the middle layer include a copolyester carbonate, a blend of polycarbonate and a copolyester carbonate or a blend with other polymers such as polyesters (polybutylene terephethalate (PBT), polyethylene terephthalate (PET), and the like), polyamides, acrylates—such as polymethyl methacrylates, polyethyl methacrylate, polyphthalate carbonate (PPC), polycarbonate ester (PCE), polymers comprising resorcinol arylate polyester chain members such as described above, and the like. Illustrative examples of PPC and PCE are tertiary copolymers of polycarbonate, bisphenol A isophthalate, and bisphenol A terephthalate having the Formula (XIV):

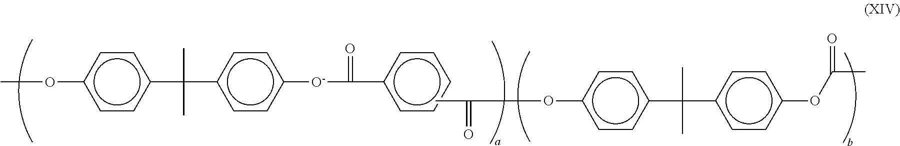

wherein a is an aromatic ester present in an amount of about 60 to about 80% by weight and b is a BPA carbonate present in an amount of about 20 to about 40% by weight, based on the total weight of the copolymer. In one embodiment, the thermoplastic polymer of the middle layer comprising a carbonate polymer will further comprise PPC, PCE, PBT, PET, and combinations comprising at least one of the foregoing. In one especially exemplary embodiment, the thermoplastic polymer comprising a carbonate polymer will further comprise PPC, PCE, and combinations comprising at least one of the foregoing.

Such other thermoplastics can be present in an amount of 0 to about 50% by weight of the other thermoplastic, specifically, about 0.5 to about 40% by weight, based on the total weight of the thermoplastic blend of the middle layer 4.

In one exemplary embodiment, the thermoplastic blend comprising the middle layer 4 will comprise PPC and a polycarbonate homopolymer prepared from bis-phenol-A and a carbonyl chloride precurser. In one exemplary embodiment, the PPC will be present in an amount of no less than or about equal to 5% by weight of PPC, based on the total weight of the thermoplastic blend of middle layer 4. In another embodiment, the PPC will be present in an amount of about 5 to about 40% by weight, based on the total weight of the thermoplastic blend of middle layer 4, while in one exemplary embodiment, the PPC will be present in an amount of about 20 to about 30% by weight, based on the total weight of the thermoplastic blend of middle layer 4.

In one embodiment, the polycarbonate or carbonate polymer will comprise aromatic polycarbonates and mixtures thereof. Generally, aromatic polycarbonates possess recurring structural units of the Formula (XV):

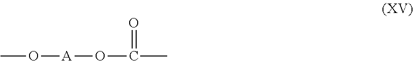

wherein A is a divalent aromatic radical of the dihydroxy compound employed in the polymer reaction. Polycarbonate prepared by melt polymerization frequently contains Fries product. A Fries product is a product of a Fries reaction. The terms “Fries reaction” and “Fries rearrangement” are used interchangeably herein, and refer to the amount of side chain branching measured as branching points. The Fries rearrangement is an undesirable side reaction that occurs during the preparation of polycarbonate using the melt process. The resultant Fries product serves as a site for branching of the polycarbonate chains, which affects flow and other properties of the polycarbonate. Although low levels of Fries products may be tolerated in polycarbonates, the presence of high levels may negatively affect performance characteristics of the polycarbonate such as toughness and moldability. The amount of Fries product may be determined by measuring the branching points via methanolysis followed by high-pressure liquid chromatography (HPLC).

The reactants utilized in the production of a polycarbonate by a polycondensation reaction are generally a dihydroxy compound and a carbonic acid diester. There is no particular restriction on the type of dihydroxy compound that may be employed. For example, bisphenol compounds represented by the general Formula (XVI) below may be used

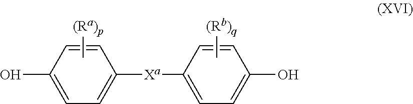

wherein R^{a} and R^{b} may be the same or different and wherein each represents a halogen atom or monovalent hydrocarbon group, and p and q are each independently integers from 0 to 4. Specifically, X represents one of the groups of Formula (XVII):

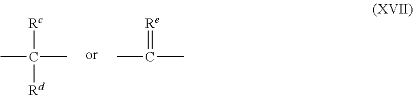

wherein R^{c} and R^{d} each independently represent a hydrogen atom or a monovalent linear or cyclic hydrocarbon group and R^{e} is a divalent hydrocarbon group. Examples of the types of bisphenol compounds that may be represented by Formula (XVII) include the bis(hydroxyaryl)alkane series such as, 1,1-bis(4-hydroxyphenyl)methane, 1,1-bis(4-hydroxyphenyl)ethane, 2,2-bis(4-hydroxyphenyl)propane (or bisphenol-A), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, bis(4-hydroxyphenyl)phenylmethane, 2,2-bis(4-hydroxy-1-methylphenyl)propane, 1,1-bis(4-hydroxy-t-butylphenyl)propane, 2,2-bis(4-hydroxy-3-bromophenyl)propane, and the like; bis(hydroxyaryl)cycloalkane series such as, 1,1-bis(4-hydroxyphenyl)cyclopentane, 1,1-bis(4-hydroxyphenyl)cyclohexane, and the like; and the like, as well as combinations comprising at least one of the foregoing bisphenol compounds.

Other bisphenol compounds that may be represented by Formula (XVI) include those wherein X is —O—, —S—, —SO— or —SO—. Examples of such bisphenol compounds are bis(hydroxyaryl)ethers such as 4,4′-dihydroxy diphenyl ether, and the like; 4,4′-dihydroxy-3,3′-dimethylphenyl ether; bis(hydroxy diaryl)sulfides, such as 4,4′-dihydroxy diphenyl sulfide, 4,4′-dihydroxy-3,3′-dimethyl diphenyl sulfide, and the like; bis(hydroxy diaryl) sulfoxides, such as 4,4′-dihydroxy diphenyl sulfoxides, 4,4′-dihydroxy-3,3′-dimethyl diphenyl sulfoxides, and the like; bis(hydroxy diaryl)sulfones, such as, 4,4′-dihydroxy diphenyl sulfone, 4,4′-dihydroxy-3,3′-dimethyl diphenyl sulfone; and the like, as well as combinations comprising at least one of the foregoing bisphenol compounds.

Other bisphenol compounds that may be utilized in the polycondensation of the carbonate polymer are represented by the formula (IV):

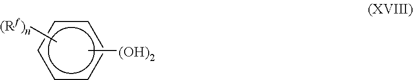

wherein, R^{f}, is a halogen atom of a hydrocarbon group having 1 to 10 carbon atoms or a halogen substituted hydrocarbon group; n is a value from 0 to 4. When n is at least 2, R^{f} may be the same or different. Examples of bisphenol compounds that may be represented by the Formula (XVIII), are resorcinol, substituted resorcinol compounds (such as 3-methyl resorcin, 3-ethyl resorcin, 3-propyl resorcin, 3-butyl resorcin, 3-t-butyl resorcin, 3-phenyl resorcin, 3-cumyl resorcin, 2,3,4,6-tetrafloro resorcin, 2,3,4,6-tetrabromo resorcin, and the like), catechol, hydroquinone, substituted hydroquinones, (such as 3-methyl hydroquinone, 3-ethyl hydroquinone, 3-propyl hydroquinone, 3-butyl hydroquinone, 3-t-butyl hydroquinone, 3-phenyl hydroquinone, 3-cumyl hydroquinone, 2,3,5,6-tetramethyl hydroquinone, 2,3,5,6-tetra-t-butyl hydroquinone, 2,3,5,6-tetrafloro hydroquinone, 2,3,5,6-tetrabromo hydroquinone, and the like), and the like, as well as combinations comprising at least one of the foregoing bisphenol compounds.

Bisphenol compounds such as 3,3,3′,3′-tetramethyl-1,1′-spirobi[indane]-6,6′-diol represented by the following Formula (IXX) may also be used.

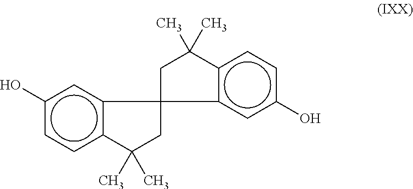

An exemplary bisphenol compound is bisphenol A. In addition, copolymeric polycarbonates may be manufactured by reacting at least two or more bisphenol compounds with the carbonic acid diesters.

Examples of the carbonic acid diester that may be utilized to produce the polycarbonates are diphenyl carbonate, bis(2,4-dichlorophenyl)carbonate, bis(2,4,6-trichlorophenyl)carbonate, bis(2-cyanophenyl)carbonate, bis(o-nitrophenyl)carbonate, ditolyl carbonate, m-cresyl carbonate, dinaphthyl carbonate, bis(diphenyl)carbonate, diethyl carbonate, dimethyl carbonate, dibutyl carbonate, dicyclohexyl carbonate, and the like, as well as combinations comprising at least one of the foregoing carbonic acid diesters. An exemplary carbonic acid diester is diphenyl carbonate.

The carbonic acid diester may contain a dicarboxylic acid and/or dicarboxylate ester. In general, it is desirable for the carbonic acid diester to contain an amount of less than or equal to about 50 mole %, specifically less than or equal to about 30 mole % of either dicarboxylic acid or dicarboxylate ester. Examples of dicarboxylic acids or dicarboxylate esters that may be utilized are terephthalic acid, isophthalic acid, sebacic acid, decanedioic acid, dodecanedioic acid, diphenyl sebacic acid, diphenyl terephthalic acid, diphenyl isophthalic acid, diphenyl decanedioic acid, diphenyl dodecanedioic acid, and the like, as well as combinations comprising at least one of the foregoing. The carbonic acid diester may contain at least two kinds of dicarboxylic acids and/or dicarboxylate esters if desired.

An additional example of a dicarboxylic acid or ester is an alicyclic dicarboxylic acid or ester. As used herein the terms “alicyclic” and “cycloaliphatic radical” have the same meaning and refer to a radical having a valance of at least one comprising an array of atoms which is cyclic but which is not aromatic. The array may include heteroatoms such as nitrogen, sulfur and oxygen or may be composed exclusively of carbon and hydrogen. Examples of cycloaliphatic radicals include cyclopropyl, cyclopentyl cyclohexyl, tetrahydrofuranyl and the like.

Non-limiting examples of alicyclic dicarboxylic acids or esters comprise an acid or ester chosen from: cyclopropanedicarboxylic acid, 1,2-cyclobutanedicarboxylic acid, 1,3-cyclobutanedicarboxylic acid, 1,2-cyclopentanedicarboxylic acid, 1,3-cyclopentanedicarboxylic acid, 1,2-cyclohexanedicarboxylic acid, 1,3-cyclohexanedicarboxylic acid, 1,4-cyclohexanedicarboxylic acid, diphenyl cyclopropanedicarboxylate, diphenyl 1,2-cyclobutanedicarboxylate, diphenyl 1,3-cyclobutanedicarboxylate, diphenyl 1,2-cyclopentanedicarboxylate, diphenyl 1,3-cyclopentanedicarboxylate, diphenyl 1,2-cyclohexanedicarboxylate, diphenyl 1,3-cyclohexanedicarboxylate, diphenyl 1,4-cyclohexanedicarboxylate, and a combination of at least two different alicyclic dicarboxylic acids or esters.

It is generally desirable for the molar ratio of the carbonic acid diester to the aromatic dihydroxy compound to be about 0.95 to about 1.20. Within this range it is generally desirable to have the molar ratio greater than or equal to about 1.01. Also desirable within this range is a molar ratio of less than or equal to about 1.10.

If desired, carbonate polymers or polycarbonates may be prepared by reacting a polyfunctional compound having at least three functional groups with the aromatic dihydroxy compound and carbonic acid diester. Exemplary polyfunctional compounds include those having a phenolic hydroxy group or a carboxyl group. An exemplary polyfunctional compound is a phenolic compound having three hydroxy groups. Examples of such polyfunctional compounds are 1,1,1-tris(4-hydroxyphenyl)ethane, 2,2′,2″-tris(4-hydroxyphenyl)diisopropyl benzene, α-methyl-α,α′,α′-tris(4-hydroxyphenyl)-1,4-diethyl benzene, α,α′,′″-tris(4-hydroxyphenyl)-1,3,5-triisopropyl benzene, phloroglycine, 4,6-dimethyl-2,4,6-tri(4-hydroxyphenyl)-heptane-2,1,3,5-tri(4-hydroxyphenyl) benzene, 2,2-bis-[4,4-(4, 4′-dihydroxyphenyl)-cyclohexyl]-propane, trimellitic acid, 1,3,5-benzene tricarboxylic acid, pyromellitic acid, and the like, as well as combinations comprising at least one of the foregoing polyfunctional compounds. Exemplary polyfunctional compounds are 1,1,1-tris(4-hydroxyphenyl)ethane and α,α′,α′-tris(4-hydroxyphenyl)-1,3,5-triisopropyl benzene, or combinations comprising at least one of the foregoing compounds.

Polyfunctional compounds may generally be used in amounts of less than or equal to about 0.03 moles per mole of aromatic dihydroxy compound. Within this range, it is desirable to use the polyfunctional compounds in amounts of greater than or equal to about 0.001 moles per mole of aromatic dihydroxy compound. Also desirable within this range, is an amount of polyfunctional compound of less than or equal to about 0.02 moles, specifically less than or equal to about 0.01 mole per mole of aromatic dihydroxy compound.

While not wishing to be bound to a particular theory, it is believed that carbonate polymers having a weight average molecular weight of about 17,000 to about 22,000 on an absolute molecular weight scale are suitable for injection molding, while polycarbonate compositions having weight average molecular weight of about 20,000 to about 36,000 on an absolute molecular weight scale are suitable for extrusion processing of multi-layer articles. In one exemplary embodiment, the carbonate polymer of the thermoplastic polymer of the middle layer 4 will have a weight average molecular weight in the range of about 30,000 to about 36,000 on an absolute molecular weight scale.

In one embodiment, the middle layer 4 will comprise a LEXAN® polycarbonate, a commercially available carbonate polymer product of SABIC Innovative Plastics. In another embodiment, the middle layer 4 can comprise at least one of LEXAN® 101, ML103, or 131.

Turning again to FIG. 1, it can be seen that the inner tie-layer 6 is opposite to the outer layer 2 and is in contact with middle layer 4, such contact in one exemplary embodiment being contiguous. Inner tie-layer 6 provides desirable adhesion between the multi-layer article 10 and a substrate 8 as illustrated in FIG. 6.

In one embodiment, the tie-layer 6 comprises a thermoplastic blend comprising a carbonate polymer and a bulk polymerized acrylonitrile-butadiene-styrene graft copolymer (ABS) blend. In one embodiment, the tie-layer 6 further comprises a rigid styrenic copolymer. In one embodiment, the melt flow volume of the tie-layer resin is between about 2 to about 50 cm³/10 min, as measured at 260° C./5kg, per ISO 1133 or ASTM D1238, while in another exemplary embodiment, the melt flow volume will be about 3 to about 40 cm³/10 min. In another exemplary embodiment, the melt flow volume of the tie-layer resin is between about 3 to about 30 cm³/10 min, as measured at 260° C./5kg, per ISO 1133 or ASTM D1238.

Exemplary carbonate polymer compositions include those discussed above for the carbonate polymer of the middle layer 4. In one embodiment, exemplary carbonate polymer compositions include those having a weight average molecular weight about 20,000 to about 36,000 on an absolute molecular weight scale, while in another embodiment; the carbonate polymer for use in tie-layer 6 will have a weight average molecular weight of about 21,000 to about 31,000 on an absolute molecular weight scale.

In another embodiment, exemplary carbonate polymer compositions will have a melt flow viscosity (measured at 300° C./1.2 kg) of about 3 to about 30 cm³/10 min, while in another embodiment, the carbonate polymer compositions will have a melt flow viscosity of about 3 to about 26 cm³/10 min.

The carbonate polymer component of the thermoplastic blend of tie-layer 6 may also comprise a polybutylene terephthalate (PET), a copolyester carbonate, a polybutylene terephthalate (PBT), and the like, as discussed above with respect to the carbonate polymer of middle layer 4. In one exemplary embodiment, the carbonate polymer component of the thermoplastic blend of tie-layer 6 will comprise a polycarbonate homopolymer.

The thermoplastic composition of tie-layer 6 further comprises an acrylonitrile-styrene graft copolymer or interpolymer that comprises bulk polymerized acrylonitrile-butadiene-styrene graft copolymer (ABS).

Acrylonitrile-butadiene-styrene (ABS) graft copolymers contain two or more polymeric parts of different compositions, which are bonded chemically. The graft copolymer is specifically prepared by first polymerizing a conjugated diene, such as butadiene or another conjugated diene, with a monomer copolymerizable therewith, such as styrene, to provide a polymeric backbone. After formation of the polymeric backbone, at least one grafting monomer, and specifically two, are polymerized in the presence of the polymer backbone to obtain the graft copolymer. These resins are prepared by methods well known in the art.

For example, ABS may be made by one or more of emulsion or solution polymerization processes, bulk/mass, suspension and/or emulsion-suspension process routes. In addition, ABS materials may be produced by other process techniques such as batch, semi batch and continuous polymerization for reasons of either manufacturing economics or product performance or both. In order to reduce point defects or inclusions in the inner layer of the final multi-layer article, the ABS is produced by bulk polymerization.

Emulsion polymerization of vinyl monomers gives rise to a family of addition polymers. In many instances the vinyl emulsion polymers are copolymers containing both rubbery and rigid polymer units. Mixtures of emulsion resins, especially mixtures of rubber and rigid vinyl emulsion derived polymers are useful in blends.

Such rubber modified thermoplastic resins made by an emulsion polymerization process may comprise a discontinuous rubber phase dispersed in a continuous rigid thermoplastic phase, wherein at least a portion of the rigid thermoplastic phase is chemically grafted to the rubber phase. Such a rubbery emulsion polymerized resin may be further blended with a vinyl polymer made by an emulsion or bulk polymerization process. However, at least a portion of the vinyl polymer, rubber or rigid thermoplastic phase, blended with polycarbonate, will be made by emulsion polymerization.

Suitable rubbers for use in making a vinyl emulsion polymer blend are rubbery polymers having a glass transition temperature (Tg) of less than or equal to 25° C., more preferably less than or equal to 0° C., and even more preferably less than or equal to −30° C. As referred to herein, the Tg of a polymer is the Tg value of polymer as measured by differential scanning calorimetry (heating rate 20° C./minute, with the Tg value being determined at the inflection point). In another embodiment, the rubber comprises a linear polymer having structural units derived from one or more conjugated diene monomers. Suitable conjugated diene monomers include, e.g., 1,3-butadiene, isoprene, 1,3-heptadiene, methyl-1,3-pentadiene, 2,3-dimethylbutadiene, 2-ethyl-1,3-pentadiene, 1,3-hexadiene, 2,4-hexadiene, dichlorobutadiene, bromobutadiene and dibromobutadiene as well as mixtures of conjugated diene monomers. In a preferred embodiment, the conjugated diene monomer is 1,3-butadiene.

The emulsion polymer may, optionally, include structural units derived from one or more copolymerizable monoethylenically unsaturated monomers selected from (C₂-C₁₂) olefin monomers, vinyl aromatic monomers and monoethylenically unsaturated nitrile monomers and (C₂-C₁₂) alkyl (meth)acrylate monomers. As used herein, the term “(C₂-C₁₂) olefin monomers” means a compound having from 2 to 12 carbon atoms per molecule and having a single site of ethylenic unsaturation per molecule. Suitable (C₂-C₁₂) olefin monomers include, e.g., ethylene, propene, 1-butene, 1-pentene, heptene, 2-ethyl-hexylene, 2-ethyl-heptene, 1-octene, and 1-nonene. As used herein, the term “(C₁-C₁₂) alkyl” means a straight or branched alkyl substituent group having from 1 to 12 carbon atoms per group and includes, e.g., methyl, ethyl, n-butyl, sec-butyl, t-butyl, n-propyl, iso-propyl, pentyl, hexyl, heptyl, octyl, nonyl, decyl, undecyl and dodecyl, and the terminology “(meth)acrylate monomers” refers collectively to acrylate monomers and methacrylate monomers.

The rubber phase and the rigid thermoplastic phase of the emulsion modified vinyl polymer may, optionally include structural units derived from one or more other copolymerizable monoethylenically unsaturated monomers such as, e.g., monoethylenically unsaturated carboxylic acids such as, e.g., acrylic acid, methacrylic acid, itaconic acid, hydroxy (C₁-C₁₂) alkyl (meth)acrylate monomers such as, e.g., hydroxyethyl methacrylate; (C₅-C₁₂) cycloalkyl (meth)acrylate monomers such as e.g., cyclohexyl methacrylate; (meth)acrylamide monomers such as e.g., acrylamide and methacrylamide; maleimide monomers such as, e.g., N-alkyl maleimides, N-aryl maleimides, maleic anhydride, vinyl esters such as, e.g., vinyl acetate and vinyl propionate. As used herein, the term “(C₅-C₁₂) cycloalkyl” means a cyclic alkyl substituent group having from 5 to 12 carbon atoms per group and the term “(meth)acrylamide” refers collectively to acrylamides and methacrylamides.

In some cases the rubber phase of the emulsion polymer is derived from polymerization of a butadiene, C₄-C₁₂ acrylates or combination thereof with a rigid phase derived from polymerization of styrene, C₁-C₃ acrylates, methacrylates, acrylonitrile or combinations thereof where at least a portion of the rigid phase is grafted to the rubber phase. In other instances more than half of the rigid phase will be grafted to the rubber phase.

Suitable vinyl aromatic monomers include, e.g., styrene and substituted styrenes having one or more alkyl, alkoxyl, hydroxyl or halo substituent group attached to the aromatic ring, including, e.g., -methyl styrene, p-methyl styrene, vinyl toluene, vinyl xylene, trimethyl styrene, butyl styrene, chlorostyrene, dichlorostyrene, bromostyrene, p-hydroxystyrene, methoxystyrene and vinyl-substituted condensed aromatic ring structures, such as, e.g., vinyl naphthalene, vinyl anthracene, as well as mixtures of vinyl aromatic monomers. As used herein, the term “monoethylenically unsaturated nitrile monomer” means an acyclic compound that includes a single nitrile group and a single site of ethylenic unsaturation per molecule and includes, e.g., acrylonitrile, methacrylonitrile, a-chloro acrylonitrile.

In an alternative embodiment, the rubber is a copolymer, preferably a block copolymer, comprising structural units derived from one or more conjugated diene monomers and up to 90 percent by weight (“wt %”) structural units derived from one or more monomers selected from vinyl aromatic monomers and monoethylenically unsaturated nitrile monomers, such as, a styrene-butadiene copolymer, an acrylonitrile-butadiene copolymer or a styrene-butadiene-acrylonitrile copolymer. In another embodiment, the rubber is a styrene-butadiene block copolymer that contains from 50 to 95 wt % structural units derived from butadiene and from 5 to 50 wt % structural units derived from styrene.

The emulsion derived polymers can be further blended with non-emulsion polymerized vinyl polymers, such as those made with bulk or mass polymerization techniques. A process to prepare mixtures containing polycarbonate, an emulsion derived vinyl polymer, along with a bulk polymerized vinyl polymers, is also contemplated.

The rubber phase may be made by aqueous emulsion polymerization in the presence of a radical initiator, a surfactant and, optionally, a chain transfer agent and coagulated to form particles of rubber phase material. Suitable initiators include conventional free radical initiator such as, e.g., an organic peroxide compound, such as e.g., benzoyl peroxide, a persulfate compound, such as, e.g., potassium persulfate, an azonitrile compound such as, e.g., 2,2′-azobis-2,3,3-trimethylbutyronitrile, or a redox initiator system, such as, e.g., a combination of cumene hydroperoxide, ferrous sulfate, tetrasodium pyrophosphate and a reducing sugar or sodium formaldehyde sulfoxylate. Suitable chain transfer agents include, for example, a (C₉-C₁₃) alkyl mercaptan compound such as nonyl mercaptan, t-dodecyl mercaptan. Suitable emulsion aids include, linear or branched carboxylic acid salts, with about 10 to 30 carbon atoms. Suitable salts include ammonium carboxylates and alkaline carboxylates; such as ammonium stearate, methyl ammonium behenate, triethyl ammonium stearate, sodium stearate, sodium iso-stearate, potassium stearate, sodium salts of tallow fatty acids, sodium oleate, sodium palmitate, potassium linoleate, sodium laurate, potassium abieate (rosin acid salt), sodium abietate and combinations thereof. Often mixtures of fatty acid salts derived from natural sources such as seed oils or animal fat (such as tallow fatty acids) are used as emulsifiers.

In one embodiment, the emulsion polymerized particles of rubber phase material have a weight average particle size of 50 to 800 nanometers (“nm”), more preferably, of from 100 to 500 nm, as measured by light transmission. The size of emulsion polymerized rubber particles may optionally be increased by mechanical, colloidal or chemical agglomeration of the emulsion polymerized particles, according to known techniques.

The rigid thermoplastic phase comprises one or more vinyl derived thermoplastic polymers and exhibits a Tg of greater than 25° C., preferably greater than or equal to 90° C. and even more preferably greater than or equal to 100° C.

In another instance, the rigid thermoplastic phase comprises a vinyl aromatic polymer having first structural units derived from one or more vinyl aromatic monomers, preferably styrene, and having second structural units derived from one or more monoethylenically unsaturated nitrile monomers, preferably acrylonitrile. In other cases, the rigid phase comprises from 55 to 99 wt %, still more preferably 60 to 90 wt %, structural units derived from styrene and from 1 to 45 wt %, still more preferably 10 to 40 wt %, structural units derived from acrylonitrile.

The amount of grafting that takes place between the rigid thermoplastic phase and the rubber phase may vary with the relative amount and composition of the rubber phase. In one embodiment, from 10 to 90 wt %, often from 25 to 60 wt %, of the rigid thermoplastic phase is chemically grafted to the rubber phase and from 10 to 90 wt %, preferably from 40 to 75 wt % of the rigid thermoplastic phase remains “free”, i.e., non-grafted.

The rigid thermoplastic phase of the rubber modified thermoplastic resin may be formed solely by emulsion polymerization carried out in the presence of the rubber phase or by addition of one or more separately polymerized rigid thermoplastic polymers to a rigid thermoplastic polymer that has been polymerized in the presence of the rubber phase. In one embodiment, the weight average molecular weight of the one or more separately polymerized rigid thermoplastic polymers is from about 50,000 to about 100,000 g/mol.

In other cases, the rubber modified thermoplastic resin comprises a rubber phase having a polymer with structural units derived from one or more conjugated diene monomers, and, optionally, further comprising structural units derived from one or more monomers selected from vinyl aromatic monomers and monoethylenically unsaturated nitrile monomers, and the rigid thermoplastic phase comprises a polymer having structural units derived from one or more monomers selected from vinyl aromatic monomers and monoethylenically unsaturated nitrile monomers. In one embodiment, the rubber phase of the rubber modified thermoplastic resin comprises a polybutadiene or poly(styrene-butadiene) rubber and the rigid thermoplastic phase comprises a styrene-acrylonitrile copolymer. Vinyl polymers free of alkyl carbon-halogen linkages, specifically bromine and chlorine carbon bond linkages can provide melt stability.

In some instances it is desirable to isolate the emulsion vinyl polymer or copolymer by coagulation in acid. In such instances the emulsion polymer may be contaminated by residual acid, or species derived from the action of such acid, for example carboxylic acids derived from fatty acid soaps used to form the emulsion. The acid used for coagulation may be a mineral acid; such as sulfuric acid, hydrochloric acid, nitric acid, phosphoric acid or mixtures thereof. In some cases the acid used for coagulation has a pH less than about 5.

Bulk polymerized ABS (BABS) (e.g., bulk polymerized ABS graft copolymer) comprises an elastomeric phase comprising one or more unsaturated monomers, such as butadiene having a Tg of less than or equal to 10° C., and a polymeric graft phase (e.g., rigid graft phase) comprising a copolymer of one or more monovinylaromatic monomers such as styrene and one or more unsaturated nitrile monomers, such as acrylonitrile having a Tg greater than 50° C. Rigid generally means a Tg greater than room temperature, e.g., a Tg greater than about 21° C. Such bulk polymerized ABS can be prepared by first providing the elastomeric polymer, then polymerizing the constituent monomers of the rigid graft phase in the presence of the elastomer to obtain the elastomer modified copolymer. As the rigid graft phase copolymer molecular weight increases, a phase inversion occurs in which some of the rigid graft phase copolymer will be entrained within the elastomeric phase. Some of the grafts can be attached as graft branches to the elastomer phase.

Polybutadiene homopolymer can be used as the elastomer phase. The elastomer phase of the bulk polymerized ABS can comprise butadiene copolymerized with less than or equal to 25 wt. % of another conjugated diene monomer of Formula (XX):

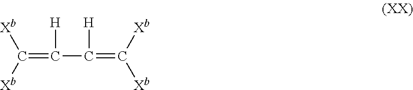

wherein each X^{b} is independently C₁-C₅ alkyl. Examples of conjugated diene monomers that may be used are isoprene, 1,3-heptadiene, methyl-1,3-pentadiene, 2,3-dimethyl-1,3-butadiene, 2-ethyl-1,3-pentadiene; 1,3- and 2,4-hexadienes, and the like, as well as combinations comprising at least one of the foregoing conjugated diene monomers. A specific conjugated diene is isoprene.

The elastomeric butadiene phase can additionally be copolymerized with less than or equal to 25 wt. %, specifically less than or equal to 15 wt. %, of another comonomer. Examples include monovinylaromatic monomers containing condensed aromatic ring structures such as vinyl naphthalene, vinyl anthracene and the like, or monomers of Formula (XXI):

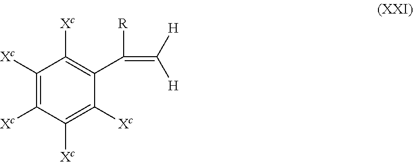

wherein each X^{c} is independently hydrogen, C₁-C₁₂ alkyl, C₃-C₁₂ cycloalkyl, C₆-C₁₂ aryl, C₇-C₁₂ aralkyl, C₇-C₁₂ alkaryl, C₁-C₁₂ alkoxy, C₃-C₁₂ cycloalkoxy, C₆-C₁₂ aryloxy, chloro, bromo, or hydroxy, and R is hydrogen, C₁-C₅ alkyl, bromo, or chloro. Examples of suitable monovinylaromatic monomers copolymerizable with the butadiene include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like, and combinations comprising at least one of the foregoing monovinylaromatic monomers. In one embodiment, the butadiene is copolymerized with less than or equal to 12 wt. % styrene and/or alpha-methyl styrene.

Other monomers that can be copolymerized with the butadiene are monovinylic monomers such as itaconic acid, acrylamide, N-substituted acrylamide or methacrylamide, maleic anhydride, maleimide, N-alkyl-, aryl-, or haloaryl-substituted maleimide, glycidyl (meth)acrylates, and monomers of the generic Formula (XXII):

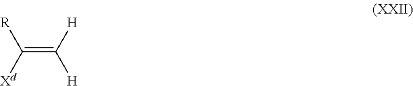

wherein R is hydrogen, C₁-C₅ alkyl, bromo, or chloro, and X^{d} is cyano, C₁-C₁₂ alkoxycarbonyl, C₁-C₁₂ aryloxycarbonyl, hydroxy carbonyl, or the like. Examples of monomers of Formula (XXII) include acrylonitrile, ethacrylonitrile, methacrylonitrile, alpha-chloroacrylonitrile, beta-chloroacrylonitrile, alpha-bromoacrylonitrile, acrylic acid, methyl (meth)acrylate, ethyl (meth)acrylate, n-butyl (meth)acrylate, t-butyl (meth)acrylate, n-propyl (meth)acrylate, isopropyl (meth)acrylate, 2-ethylhexyl (meth)acrylate, and the like, and combinations comprising at least one of the foregoing monomers. Monomers such as n-butyl acrylate, ethyl acrylate, and 2-ethylhexyl acrylate are commonly used as monomers copolymerizable with the butadiene.

The particle size of the butadiene phase is not critical for bulk polymerized rubber substrates, and can be, for example about 0.01 micrometers (μm) to about 20 μm, specifically about 0.5 μm to about 10 μm, more specifically about 0.6 μm to about 1.5 μm. Particle size may be measured by light transmission methods or capillary hydrodynamic chromatography (CHDF). The butadiene phase can provide about 5 wt. % to about 95 wt. % of the total weight of the bulk polymerized ABS, more specifically about 20 wt. % to about 90 wt. %, and even more specifically about 40 wt. % to about 85 wt. % of the bulk polymerized ABS, the remainder being the rigid graft phase.

The rigid graft phase comprises a copolymer formed from a styrenic monomer composition together with an unsaturated monomer comprising a nitrile group. As used herein, “styrenic monomer” includes monomers of Formula (XXI) wherein each X^{c} is independently hydrogen, C₁-C₄ alkyl, phenyl, C₇-C₉ aralkyl, C₇-C₉ alkaryl, C₁-C₄ alkoxy, phenoxy, chloro, bromo, or hydroxy, and R is hydrogen, C₁-C₂ alkyl, bromo, or chloro. Specific examples include styrene, 3-methylstyrene, 3,5-diethylsytyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like. Combinations comprising at least one of the foregoing styrenic monomers may be used.

Further as used herein, an unsaturated monomer comprising a nitrile group includes monomers of Formula (XXII) wherein X^{d} is cyano. Specific examples include acrylonitrile, ethacrylonitrile, methacrylonitrile, alpha-chloroacrylonitrile, beta-chloroacrylonitrile, alpha-bromoacrylonitrile, and the like. Combinations comprising at least one of the foregoing monomers may be used.

The rigid graft phase of the bulk polymerized ABS may further optionally comprise other monomers copolymerizable therewith, including other monovinylaromatic monomers and/or monovinylic monomers such as itaconic acid, acrylamide, N-substituted acrylamide or methacrylamide, maleic anhydride, maleimide, N-alkyl-, aryl-, or haloaryl-substituted maleimide, glycidyl (meth)acrylates, and monomers of the generic Formula XXIII. Specific comonomers include C₁-C₄ alkyl (meth)acrylates, (e.g., methyl methacrylate).

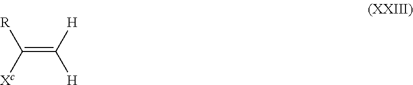

The rigid graft phase generally comprises about 10 wt. % to about 99 wt. %, specifically about 40 wt. % to about 95 wt. %, more specifically about 50 wt. % to about 90 wt. % of the styrenic monomer; about 1 wt. % to about 90 wt. %, specifically about 10 wt. % to about 80 wt. %, more specifically about 10 wt. % to about 50 wt. % of the unsaturated monomer comprising a nitrile group; and about 0 to about 25 wt. %, specifically about 1 wt. % to about 15 wt. % of other comonomer, each based on the total weight of the rigid graft phase.

The bulk polymerized ABS can further comprise a separate matrix or continuous phase of ungrafted rigid copolymer that can be simultaneously obtained with the bulk polymerized ABS. The bulk polymerized ABS can comprise about 40 wt. % to about 95 wt. % elastomer-modified graft copolymer and about 5 wt. % to about 65 wt. % rigid graft copolymer, based on the total weight of the bulk polymerized ABS. In another embodiment, the bulk polymerized ABS can comprise about 50 wt. % to about 85 wt. %, more specifically about 75 wt. % to about 85 wt. % elastomer-modified graft copolymer, together with about 15 wt. % to about 50 wt. %, more specifically about 15 wt. % to about 25 wt. % rigid graft copolymer, based on the total weight of the bulk polymerized ABS.

A variety of bulk polymerization methods for ABS-type resins can be employed. In multizone plug flow bulk processes, a series of polymerization vessels (or towers) are consecutively connected to each other, providing multiple reaction zones. The elastomeric butadiene can be dissolved in one or more of the monomers used to form the rigid graft phase, and the elastomer solution is then fed into the reaction system. During the reaction, which can be thermally or chemically initiated, the elastomer is grafted with the rigid graft copolymer (e.g., SAN). Bulk copolymer (referred to also as free copolymer, matrix copolymer, or non-grafted copolymer) is also formed within the continuous phase containing the dissolved rubber. As polymerization continues, domains of free copolymer are formed within the continuous phase of rubber/comonomers to provide a two-phase system. As polymerization proceeds further, and more free copolymer is formed, the elastomer-modified graft copolymer starts to disperse itself as particles in the free copolymer and the free copolymer becomes a continuous phase (i.e., phase inversion). Some free copolymer is generally occluded within the elastomer-modified graft copolymer phase. Following the phase inversion, additional heating can be used to complete polymerization.

Numerous modifications of this basic process have been described, for example in U.S. Pat. No. 3,511,895, which describes a continuous bulk polymerized ABS process that provides controllable molecular weight distribution and microgel particle size using a three-stage reactor system. In the first reactor, the elastomer/monomer solution is charged into the reaction mixture under high agitation to precipitate discrete rubber particle uniformly throughout the reactor mass before appreciable cross-linking can occur. Solid levels of the first, the second, and the third reactor are carefully controlled so that molecular weights fall into a desirable range. U.S. Pat. No. 3,981,944 discloses extraction of the elastomer particles using the styrenic monomer to dissolve/disperse the elastomer particles prior to the addition of the unsaturated monomer comprising a nitrile group and any other comonomers. U.S. Pat. No. 5,414,045 discloses reacting in a plug flow grafting reactor, a liquid feed composition comprising a styrenic monomer composition, an unsaturated nitrile monomer composition, and an elastomeric butadiene polymer to a point prior to phase inversion, and reacting the first polymerization product (i.e., a grafted elastomer) therefrom in a continuous-stirred tank reactor to yield a phase inverted second polymerization product that then can be further reacted in a finishing reactor, and then devolatilized to produce the desired final product.

In another embodiment, the BABS as used in the present application can be manufactured using a plug flow reactor in series with a stirred, boiling reactor as described, for example, in U.S. Pat. No. 3,981,944 and U.S. Pat. No. 5,414,045.

In various embodiments, the bulk polymerized ABS (BABS) can contain greater than or equal to 10 wt. % elastomeric butadiene polymer and greater than or equal to 10 wt. % acrylonitrile. The microstructure is phased inverted, with occluded SAN in an elastomeric butadiene polymer phase in a rigid copolymer matrix such as a SAN matrix.

In preparing the graft copolymer, it is normal to have a certain percentage of the polymerizing monomers that are grafted on the polymeric backbone combine with each other and occur as free copolymer. If styrene is utilized as one of the grafting monomers and acrylonitrile as the second grafting monomer, a certain portion of the composition will copolymerize as free styrene-acrylonitrile copolymer (SAN). In the case where alpha-methylstyrene (or other monomer) is substituted for the styrene in the composition used in preparing the graft polymer, a certain percentage of the composition may be an alpha-methylstyrene-acrylonitrile copolymer. Also, there are occasions where a copolymer, such as alpha-methylstyrene-acrylonitrile, is added to the graft polymer copolymer blend. Thus, the graft copolymer may, optionally, comprise up to about 80% of free copolymer, based on the total weight of the graft copolymer. In one exemplary embodiment, the thermoplastic polymer of the inner tie-layer 6 as seen in FIG. 1 will comprise bulk polymerized ABS and SAN copolymer.

Optionally, the polymeric backbone may be an acrylate rubber, such as the polymerization product of n-butyl acrylate, ethyl acrylate, 2-ethylhexyl acrylate, mixtures comprising at least one of the foregoing, and the like. Additionally, minor amounts of a diene may be copolymerized in the acrylate rubber backbone to yield improved grafting with the matrix polymer.

Styrene butadiene rubber or copolymers of butadiene rubbers with a glass transition temperature of less than 0° C. are especially suitable.

Bulk polymerized acrylonitrile-butadiene-styrene graft copolymers are known in the art and many are commercially available, including, for example, the high-rubber acrylonitrile-butadiene-styrene resins available from SABIC Innovative Plastics as BLENDEX® grades BDT5510 and BDT6500.

Bulk polymerized ABS polymers and resins having an average particle size of about 0.1 micrometers to about 5 micrometers can be employed, with bulk polymerized ABS having an average particle size of about 0.1 micrometers to about 2 micrometers being used in one exemplary embodiment.

Bulk polymerized ABS polymers and resins having a cross-link density of about 40 to about 90% can be employed, and specifically, bulk polymerized ABS having a cross-link density of about 45 to about 80%.

ABS prepared by emulsion polymerization is a relatively inexpensive process. Emulsion polymerized ABS is made in water to which soap is added to form monomer droplets, which are then polymerized to form polymers. A strong acid or salt can be used to coagulate the material into a solid form, which is then dried. Emulsion polymerization can be carried out to 100% conversion of monomer to polymer. Emulsion polymers are unclean because the polymers contain many impurities, e.g., soap, strong acid, salt. The many impurities found in emulsion polymerized ABS can react adversely when combined with another polymer, e.g., polycarbonate, because many of the impurities are degradation catalysts.

ABS prepared by bulk polymerization is a longer and more expensive process as compared to emulsion polymerization. Bulk polymerized ABS is made in a system where the monomer is the solvent for the reaction. A small amount of catalyst may be present as well as a small amount of solvent. The polymerization reaction is not carried to 100% completion. Any excess solvent is removed from the polymer in a device, e.g., a devolatilization extruder. Bulk polymerization is a cleaner process as compared to emulsion polymerization since the monomer is the solvent for the reaction and thus no soap, strong acid and/or salt is required for bulk polymerization. Bulk polymerization results in polymers with fewer impurities and thus less chance of an adverse reaction when the bulk polymerized ABS is combined with another polymer, e.g., polycarbonate.

In one embodiment, the thermoplastic blend of the inner tie-layer 6, of FIG. 1, will comprise one or more PC-emulsion ABS polymers or resins commercially available from SABIC Innovative Plastics under the trade name CYCOLOY®. In one exemplary embodiment, the PC-emulsion ABS polymer will be one or more of CYCOLOY(T C1000HF, C1200, MC8800, MC8002, and Formula A of Table 2 with CYCOLOY® grades C1000HF, MC8002 and Formula A of Table 2 being used in particularly exemplary embodiments, and Formula A of Table 2 being used in an especially exemplary embodiment.

In another embodiment, the thermoplastic blend of the inner tie-layer 6 as seen in FIG. 1, will comprise PC-bulk ABS polymer(s) commercially available from SABIC Innovative Plastics under the trade name CYCOLOY®. In yet another embodiment, the thermoplastic blend of the inner tie-layer 6 can comprise PC-bulk ABS polymer(s) commercially available from the Dow Chemical Company under the trade name Dow Pulse®. In one exemplary embodiment, the PC-bulk ABS polymer can be Formula B of Table 2, Formula C of Table 2, Formula D of Table 2 or Formula E of Table 2, or combinations comprising at least one of the foregoing. In another exemplary embodiment, the PC-bulk ABS polymer(s) can be Dow Pulse® 2000 EZ, commercially available from DOW Chemical Company.

In one embodiment, the thermoplastic polymer of tie-layer 6 will comprise about 25 to about 80 percent by weight (% by weight) of the polycarbonate, about 10 to about 35% by weight of the bulk polymerized ABS and about 10 to about 40% by weight of SAN based on the total weight of the tie-layer. In another embodiment, the thermoplastic polymer of tie-layer 6 will comprise about 40% to about 80% by weight of the polycarbonate, about 10% to about 30% by weight of the bulk polymerized ABS and about 10% to about 30% by weight of SAN, based on the total weight of the tie-layer. In one exemplary embodiment, the thermoplastic polymer of tie-layer 6 will comprise about 40% to about 76% by weight of the polycarbonate, about 12% to about 30% by weight of the bulk polymerized ABS and about 12% to about 30% by weight of SAN, based on the total weight of the tie-layer.

The thermoplastic polymer of the inner tie-layer can optionally comprise other components such as art-recognized additives including, but not limited to, stabilizers, color stabilizers, heat stabilizers, light stabilizers, UV screeners, UV absorbers, flame retardants, anti-drip agents, flow aids, plasticizers, ester interchange inhibitors, antistatic agents, mold release agents, fillers, and colorants such as metal flakes, glass flakes and beads, ceramic particles, other polymer particles, dyes and pigments which may be organic, inorganic or organometallic.

The exact thickness of the tie-layer 6 will be determined by the desired application. In one embodiment, the tie-layer 6 is typically about 0.08 to about 0.76 mm thick, while in another embodiment, the thickness of inner tie-layer 6 will be about 0.08 to 0.3 mm thick. In one exemplary embodiment, the tie-layer 6 is about 0.08 to about 0.15 mm thick, while in another embodiment, the thickness will be about 0.23 to about 0.3 mm thick.

Generally, the total thickness of the multi-layer article is about 0.51 to about 5.08 mm. In one exemplary embodiment, the multi-layer article 10 is about 0.76 to about 1.4 mm thick.

The multi-layer article may be made by any one of a variety of manufacturing methods including but not limited to co-injecting molding, co-extrusion lamination, co-extrusion blow film molding, co-extrusion, overmolding, multi-shot injection molding, sheet molding, and the like. In one embodiment, the multi-layer article may be made by co-extrusion lamination. In another embodiment, the outer layer 2 may be laminated on a separate, prior extruded film put on a roll. In such an embodiment, the outer layer 2 may comprise at least one sub-layer that comprises an adhesive or adherent composition.

In one embodiment, the multi-layer article 10 is prepared by co-extrusion lamination wherein the layers are simultaneously extruded through a sheet or film die orifice that may be of a single manifold or multi-manifold design. While still in the molten state, the layers are pressed together and then compressed by being passed through the nip of a pair of rolls that may be heated. The article is then cooled. The thickness of the multi-layer article 10 is determined by the desired application.

In another embodiment, the multi-layer article 10 is formed by co-extrusion wherein the individual molten layers 2, 4, and 6 are injected together and extruded through a die orifice thereby extruding a multi-layer sheet or film and then cooled.

In yet another embodiment, a process to form the multi-layer article 10 involves the co-extrusion blow film process wherein multi-layers are extruded to form a tubular parison that is then blow molded into a hollow article that is subsequently slit to prepare a flat multi-layer article 10.

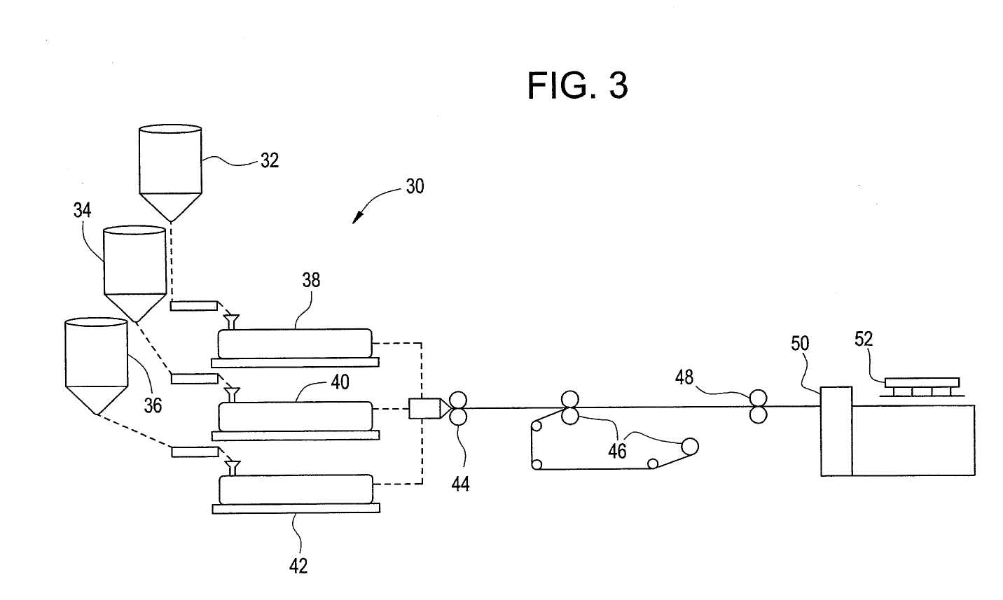

In one exemplary embodiment, the multi-layer article will be made by co-extrusion. As shown in FIG. 3, a schematic view of an extrusion mechanism designated by reference numeral 30, the multi-layer article 10 may be formed by co-extrusion of the layers 2, 4, and 6, respectively from hoppers/extruders 32/38, 34/40, and 36/42. The extruder 30 comprises a first hopper 32, a second hopper 34, and a third hopper 36 for the transfer of material to a corresponding first extruder 38, second extruder 40, and third extruder 42, respectively. In this manner, each hopper and each extruder may be adapted to process compositions of differing extrusion temperatures and viscosities. Each extruder transfers molten material to a roll stack 44 for compression of the separate compositions into the multi-layer article 10. The multi-layer article 10 may be further processed onto rolls by a masking roll 46, or pulled into sheets by a pull roll 48. The sheets of multi-layer article 10 may be cut into sheets of smaller dimension at a shear station 50 and placed in a sheet stacker 55.

The extrusion mechanism 30 processes the layers 2, 4, and 6 having differing process temperatures into the multi-layer article 10. In one exemplary example, the first extruder 38 operates to process the resorcinol arylate polyester outer layer 2 at a temperature of about 400 to about 550° F. (about 204 to about 288° C.), specifically about 400 to about 500° F. (about 240 to about 260° C.), and more specifically about 440 to about 480° F. (227 to about 249° C.). The second extruder 40 operates to process the thermoplastic polymer comprising a polycarbonate composition of middle layer 4 at a temperature of about 400 to about 550° F. (about 204 to about 288° C.), specifically about 420 to about 530° F. (about 216 to about 277° C.), and more specifically 430 to about 530° F. (about 221 to about 277° C.). A third extruder 42 operates to process the inner tie-layer at a temperature of about 400 to about 530° F. (about 240 to about 277° C.), specifically about 420 to about 500° F. (about 216 to about 260° C.), and more specifically about 440 to about 480° F. (about 227 to about 249° C.).

The layers 2, 4, and 6 as such are compressed into suitable form as a multi-layer article 10.

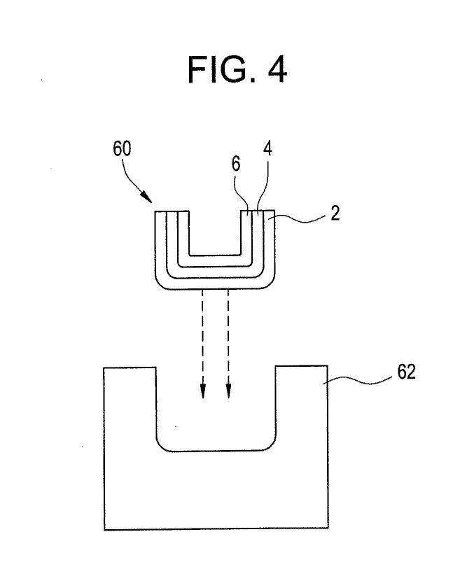

In one exemplary embodiment, the thermoformable multi-layer article 10 may be made into a formed multi-layer article 60 having any desired configuration as illustrated in FIG. 4. It will be appreciated that the cross-sectional view of a formed multi-layer article is identical to that of the multi-layer article 10 of FIG. 1. However, the shape of the formed multi-layer article 60 may have a configuration corresponding to a substrate 8 or a mold 62 as illustrated in FIG. 4. The multi-layer article 10 may be formed into a formed multi-layer article 60 by any one of a variety of methods, including but not limited to, thermoforming, compression forming, vacuum forming and the like.

Turning now to FIG. 2, a sectional view of a formed article 20 can be seen. Formed article 20 comprises a multi-layer article 10 adhered or bonded to a substrate 8. Inner tie-layer 6 is adhered to the substrate 8 while simultaneously providing good adhesion to the middle layer 4 of multi-layer article 10.

The substrate 8 employed may be any of a variety of compositions including but not limited to thermoset materials, thermoplastic materials, foamed materials, reinforced materials, and combinations comprising at least one of the foregoing. Illustrative examples include polyurethane compositions including polyurethane foam and fiber reinforced polyurethane, polypropylene including fiber-reinforced polypropylene, polycarbonate/PBT blends and the like. Reinforcing fibers include carbon fibers, glass and the like.

In one embodiment, the substrate 8 will be at least one of reinforced thermoplastic polyurethane, foamed thermoplastic polyurethane, and combinations comprising at least one of the foregoing. In one exemplary embodiment, the substrate 8 will be at least one of glass fiber-reinforced polyurethane, carbon fiber-reinforced polyurethane, foamed thermoplastic polyurethane, and combinations comprising at least one of the foregoing.

The bonding of inner tie-layer 6 to substrate 8 may result from molding, adhesives, chemical bonding, mechanical bonding, and the like, as well as combinations comprising at least one of the foregoing. In one exemplary embodiment, the bonding of the inner tie-layer 6 to substrate 8 will result from the injection molding of a substrate 8 directly onto the inner tie-layer 6.

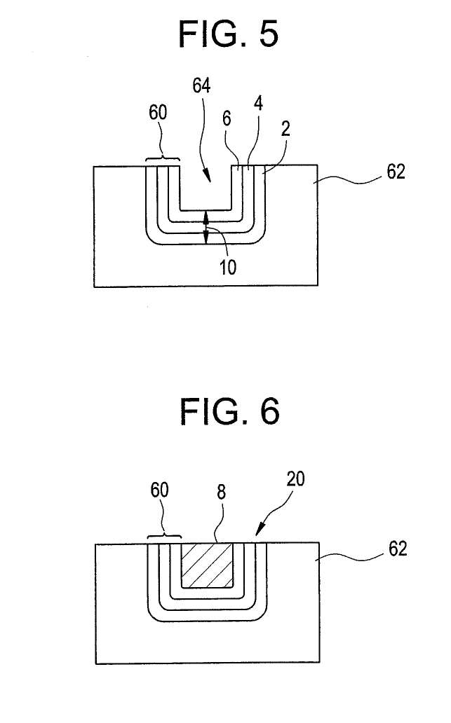

Also disclosed is a forming method for making a formed article as illustrated in FIGS. 5 and 6. The disclosed method comprises providing the disclosed multi-layer article 10; placing the multi-layer article 10 into a mold 62 so that a cavity 64 is formed behind or in back of tie-layer 6 of the multi-layer article 10; and placing a substrate 8 into the cavity 64 behind the multi-layer article 10 wherein the inner tie-layer 6 of the multi-layer article 10 bonds or is adhered to the substrate 8 to provide a formed article 20.

In one embodiment as shown in FIGS. 5 and 6, the multi-layer article 10 placed into the mold 62 may be a formed multi-layer article 60. In one embodiment, the formed multi-layer article 60 may have a shape that substantially conforms to the mold 62.

The disclosed method may further comprise cooling the formed article and/or removing the formed article 20 from the mold 62. In one embodiment, the formed article 20 is cooled and subsequently removed from the mold.

The placing of the substrate 8 into the cavity 64 may be done in a variety of ways, including injection molding, reaction injection molding, long fiber reinforced injection molding, and the like. In one embodiment, the substrate 8 is injected into the cavity 64 by reaction injection molding. In one embodiment, the substrate 8 is injected as a liquid and is then molded to form a semi-solid or solid substrate 8.

The molded article 20 is especially applicable for automotive parts including but not limited to exterior automotive panels such as door panels, roofs, hood panels, and the like.

The following non-limiting examples further illustrate the various embodiments described herein.

### Examples

### Example 1

Nine multi-layer articles with different tie-layer compositions having a thermoplastic blend comprising PC/ABS/SAN were prepared, as shown in Table 4. Table 1 provides a description of the raw materials used to make the various layer formulations, while Table 2 describes the specific formulations of the various tie layers prepared at SABIC Innovative Plastics. Table 3 describes the formulations of the outer and middle layers, also prepared at SABIC Innovative Plastics.

Each article was made of an outer layer (Formula O) of an iso terephthalic resorcinol/bisphenol A copolymer, a middle layer (Formula M) of a polycarbonate homopolymer prepared from bisphenol A and a carbonyl chloride as described in Table 3, and an inner tie-layer consisting of a blend of polycarbonate (PC), acrylonitrile-butadiene-styrene graft copolymer (ABS), and styrene acrylonitrile copolymer (SAN) of varying ABS types as set forth in Table 4.

Sample 2 was prepared using a PC-emulsion ABS polymer commercially available from Bayer as the inner tie-layer. Samples 5 and 9 were prepared using a PC-bulk ABS polymer commercially available from Dow Chemical as the inner tie-layer. The inner tie-layer for Samples 1, 3, 4, 6, 7, and 8 were prepared at SABIC Innovative Plastics according to the sample formulations listed in Table 2. The raw materials used in making the sample formulations in Tables 2 and 3 are described in Table 1. The average thickness of the outer layer was 0.13 to 0.38 mm, the average thickness of the middle layer was 0.38 to 1.02 mm, and the average thickness of the inner layer was 0.1 to 0.38 mm. The total thickness of the articles was 0.76 to 1.4 mm.

TABLE 1
Description of Raw Materials

| Component | Description | Supplier |
|---|---|---|
| PC-1 | Bisphenol A polycarbonate, Mw = 29,000 to 31,000 | SABIC IP |
| | (absolute PC molecular weight scale) | |
| PC-2 | Bisphenol A polycarbonate, Mw = 35,000 to 37,000 | SABIC IP |
| | (absolute PC molecular weight scale) | |
| PC-3 | Bisphenol A polycarbonate, Mw = 21,000 to 23,000 | SABIC IP |
| | (absolute PC molecular weight scale) | |
| PEC-1 | Blend of 25% by weight Polyester carbonate, Mw = | SABIC IP |
| | 28,000 to 29,000, 60% ester content with a 50:50 | |
| | isophthalate/terephthalate ratio and 75% by weight PC | |
| | (Bisphenol A polycarbonate, Mw = 30,000 to 37,000 | |
| | (absolute PC molecular weight scale)) | |
| PEC-2 | Polyester carbonate, Mw = 27,000 to 30,000, 80% ester | SABIC IP |
| | content with a 93:7 isophthalate/terephthalate ratio | |
| PEC-3 | Polyester carbonate, Mw = 20,000 to 22,000; with ~80 | SABIC IP |
| | mol % resorcinol phthalate ester content with a 50:50 | |
| | isophthalate/terephthalate ratio and the remaining as | |
| | mixture of BPA and resorcinol carbonate as described in | |
| | U.S. Pat. No. 6,689,474(B2) and U.S. Pat. No. 6,559,270(B1) | |
| BABS-1 | Bulk Acrylonitrile Butadiene Styrene with nominal 16% | SABIC IP |
| | butadiene and content and nominal 15% acrylonitrile | |
| | content, phase inverted with occluded SAN in a butadiene | |
| | phase in SAN matrix | |
| HRG | Emulsion process ABS with a 50% polybutadiene content | SABIC IP |
| | with a nominal 80 nanometer emulsion particle size | |
| | coagulated to a 200 to 500 nanometer broad particle size | |
| | that is then is grafted with SAN copolymer with a nominal | |
| | 75% styrene, 25% acrylonitrile content (overall 50% | |
| | polybutadiene) | |
| MBS | MBS is nominal 75-82 wt. % butadiene core with a | Rohm & |
| | balance styrene-methyl methacrylate shell. (Trade name | Haas |
| | EXL-2691A) | |
| PC-ST | Polycarbonate-Polysiloxane copolymer with 20% eugenol | SABIC IP |
| | endcapped siloxane D-50, nominal 30,000 MW on | |
| | absolute PC scale | |
| SAN-1 | Styrene-Acrylonitrile Copolymer with nominal 23 to 25% | SABIC IP |
| | acrylonitrile content, with a molecular weight of about | |
| | 97,000 (Calibrated on Polystyrene standards based GPC | |
| | weight average molecular weight) | |
| SAN-2 | Styrene-Acrylonitrile Copolymer with nominal 26 to 28% | SABIC IP |
| | acrylonitrile content, with a molecular weight of about | |
| | 170,000 (Calibrated on Polystyrene standards based GPC | |
| | weight average molecular weight) | |
| SAN-3 | Styrene-Acrylonitrile Copolymer with nominal 35 to 37% | SABIC IP |
| | acrylonitrile content, with a molecular weight of about | |
| | 84,000 (Calibrated on Polystyrene standards based GPC | |
| | weight average molecular weight) | |
| SAN-4 | Styrene-Acrylonitrile Copolymer with nominal 23 to 25% | SABIC IP |
| | acrylonitrile content, with a molecular weight of about | |
| | 65,000 (Calibrated on Polystyrene standards based GPC | |
| | weight average molecular weight) | |

TABLE 2
Inner Tie-Layer Formula Descriptions

| Formula | PC-1 | PC-2 | PC-3 | PEC-1 | PC-ST | SAN-1 | SAN-2 | SAN-3 | SAN-4 | PC-ST | MBS | BABS | HRG |
|---|---|---|---|---|---|---|---|---|---|---|---|---|---|
| A¹ | 64.7 | 0 | 0 | 0 | 0 | 15.9 | 0 | 0 | 0 | 0 | 0 | 0 | 18.8 |
| B² | 35.6 | | 35.6 | 0 | 0 | | 0 | 0 | 5.5 | 0 | 4.4 | 17.7 | 0 |
| C³ | 0 | 48.7 | 0 | 17.8 | 0 | 0 | 9.2 | 0 | 0 | 0 | 0 | 23.5 | 0 |
| D³ | 0 | 65 | 0 | 0 | 0 | 0 | 0 | 7 | 0 | 0 | 0 | 27.2 | 0 |
| E | 0 | 54.2 | 0 | 0 | 20 | 10 | 0 | 0 | 0 | 0 | 0 | 15 | 0 |

¹Also contains 0.6% stabilizers.
²Also contains 1.2% stabilizers and mold release.
³Also contains 0.8% stabilizers.

TABLE 3
Formula Descriptions for Middle and Outer Layers

| Formula | PC-1 | PC-3 | PEC-2 | PEC-3 |
|---|---|---|---|---|
| M¹ | 49.8 | 24.9 | 24.9 | 0 |
| O² | 0 | 0 | 0 | 99.9 |

¹Also contains 0.1% stabilizers and 0.3% colorants.
²Also contains 0.1% stabilizers.

TABLE 4
Tie-Layer Type & Point Defect Inspections

| | | | | Adhesion between middle layer | |
|---|---|---|---|---|---|
| | | | % inspection | (PC) and inner tie-layer | |
| Film Sample | Tie layer | ABS type | yield | (PC-ABS), lbf/in (N/m) | |
| 1 | Formula A | Emulsion | 67 | 8 | (1401) |
| 2 | Bayer ® T-85 | Emulsion | 0 | 6.7 | (1173) |
| 3 | Formula B | Bulk ABS | 99 | <4 | (<701) |
| 4 | Formula C | Bulk ABS | 82 | 1.1 | (193) |
| 5 | Dow Pulse ® 2000 EZ | Bulk ABS | 98 | 9.7 | (1699) |
| 6 | Formula A | Emulsion | 50 | 8 | (1401) |
| 7 | Formula D | Bulk ABS | 99 | <4 | (<701) |
| 8 | Formula E | Bulk ABS | 99 | <4 | (<701) |
| 9 | Dow Pulse ® 2000 EZ | Bulk ABS | 93 | 9 | (1576) |

The articles were prepared using two different co-extrusion lines.

Film samples 1 through 5 were prepared on a line having a single manifold die with a width of 30 inches (76 centimeters (cm)) and a line speed of 10.75 feet/minute (ft/min) (0.055 meters/second (m/s)). A chrome roll (240° F. (1 16° C.)) was in contact with the outer layer and another chrome roll (200° F. (93° C.)) was in contact with the inner layer. The inner layer composition was extruded using a 1 inch (2.5 cm) diameter single-stage screw extruder. The middle layer composition was extruded using a 2.5 inch (6.35 cm) diameter extruder, equipped with a two-stage barrier screw with a middle mixing section. For these samples, only 2-layer films were extruded, without the outer layer resin. Inspection samples measuring 26 inches (66.04 cm) wide by 24 inches (60.96 cm) long were cut using an online shear.

Film samples 6 through 9 were prepared on a line having a multi-manifold die with a width of 54 inches (137.2 cm) and a line speed of 3.5 to 6.0 ft/min (0.0178 to 0.0305 m/s). The inner layer composition was extruded using a 2.5 inch (6.35 cm) diameter single stage screw extruder. The middle layer composition was extruded using a 2.5 inch (6.35 cm) diameter extruder, equipped with a two-stage barrier screw with vacuum stripping. The outer layer was extruded using a 2 inch (5.08 cm) diameter single stage screw extruder. Inspection samples measuring 51 inches (129.54 cm) wide by 69 inches (175.26 cm) long were cut using an online shear.

Tie-layer defect inspections were conducted by performing 100% visual inspections of the inner layer surface of the multilayer article as it was produced on the extrusion line. Fifty or more article/film samples were inspected under each condition. For samples 1 through 5, 26 inch (6.04 cm) by 24 inch (60.96 cm) films were inspected as they were made on the line. For samples 6 through 9, 51 inches (129.54 cm) by 69 inches (175.26 cm) film samples were inspected as they were made on the line. A film having an inclusion on the tie layer surface, with an inclusion diameter (i.e., as measured along a major axis) of greater than or equal to 0.2 millimeter (mm) was considered a reject and failed the inspection. Films with smaller inclusions on the tie-layer surface were considered acceptable. Table 4 shows the results of the inspections, where % inspection yield was calculated as the number of acceptable films (i.e., films that passed) per the total films inspected.

A peel test for the adhesion strength of the tie-layer to the polycarbonate middle layer for all the samples was conducted using a 90° peel test. Peel strength was determined according to the following method. Samples of the multilayer article were cut into 6 inch (15.24 cm) by 8 inch (20.32 cm) pieces, and a 2 inch (5.08 cm) tape was applied along the 6 inch (15.24 cm) edge on the tie-layer side. This 6 inch (15.24 cm) by 8 inch (20.32 cm) piece was then backmolded on the tie layer side by injection molding with a high flow polycarbonate substrate resin, resulting in a strong bond between the tie-layer and the polycarbonate substrate, except in the 2 inch (5.08 cm) of the taped tie-layer which is untouched by the polycarbonate substrate resin. The resultant 6 inch (15.24 cm) by 8 inch (20.32 cm) plaques were then cut into 6, 1 inch (2.54 cm) wide stripes along the 8 inch (20.32 cm) edge using a saw. Layer delamination was initiated by peeling apart the multilayer article from the high flow polycarbonate substrate at the taped edge. Each strip was peeled back approximately 1 inch (2.54 cm), the peeled section doubled over by folding, and the folded sections clamped in the Instron Peel strength tester from Instron. The material was pulled apart at a crosshead separation rate of 5 inches per minute (0.212 cm/s), at an angle of 90°. Since the bond between the tie-layer and polycarbonate substrate is very strong, a tear forms in the tie-layer as the multilayer article is peeled from the high flow polycarbonate. The tear propagates into the weaker middle layer tie-layer interface, after which peeling occurs at the middle layer tie-layer interface. The peel adhesion is recorded in pounds of force per linear inch (lbF/in) strip width (Newtons/meter). The test is performed on at least 4 of the 1 inch (2.54 cm) strips and average peel adhesion is reported in lbf/in (N/m).

Table 4 shows the average results obtained from the tests. In particular, Table 4 indicates that the inner tie-layer comprising polycarbonate acrylonitrile-butadiene-styrene copolymer compositions prepared using bulk polymerized ABS resins exhibited higher % inspection yields for point defects when compared to emulsion polymerized ABS resins.

Table 4 demonstrates that multi-layer articles using Dow Pulse® 2000 EZ (Sample 5) as the inner tie-layer (comprising polycarbonate and bulk polymerized acrylonitrile-butadiene-styrene graft copolymer), exhibited adhesion to the middle polycarbonate layer of greater than 6 lbf/in (about 1050 N/m), and even greater than or equal to 8 lbf/in (about 1400 N/m), similar to articles prepared using emulsion based ABS as shown in Sample 2. However, the articles prepared with the Dow Pulse(® 2000 EZ PC-bulk ABS inner tie-layer, exhibited much fewer tie layer inclusions/defects than the articles prepared using emulsion based ABS. In particular, Samples 5 and 9, prepared using PC -bulk ABS as the tie layer, demonstrated 2% and 7% tie-layer inclusion/defects, meaning very few tie layer inclusions or defects occurred in those samples. Sample 2, prepared using PC-emulsion ABS as the tie layer, demonstrated no acceptable films per the total films inspected or 100% tie-layer inclusions/defects. On average, tie-layer defect rates were reduced from approximately about 50% to approximately about 5%. In other words, less than or equal to 20%, specifically, less than or equal to 10%, more specifically, less than or equal to 5%, and even less than or equal to 2% of bulk ABS based multi-layer articles have tie-layer inclusion defects greater than or equal to 0.2 mm in diameter.

The multi-layer articles comprising bulk polymerized acrylonitrile-butadiene-styrene based inner layer lead to the manufacture of defect-free articles for use in automotive applications. This results in improved inspection yields in manufacturing without altering the manufacturing run conditions or properties of the multi-layer articles formed therein. Hence, enhanced products can be produced by using an inner tie-layer comprising bulk polymerized acrylonitrile-butadiene-styrene based, e.g., greater than or equal to 50 wt % bulk polymerized ABS, specifically, greater than or equal to 75 wt % bulk polymerized ABS, more specifically, greater than or equal to 90 wt % bulk polymerized ABS, and yet more specifically, greater than or equal to 95 wt % bulk polymerized ABS, and especially, 100 wt % bulk polymerized ABS, wherein the weight percent is based upon a total weight of the ABS in the inner tie-layer. Finally, the multi-layer articles are advantageous in that they can be manufactured by co-extrusion.

The multi-layer articles with reduced tie-layer defects allow for the production of formed articles having the defect-free surface quality and appearance necessary for exterior automotive parts while simultaneously providing improved adhesion to a substrate. In particular, formed articles produced with the PC-bulk polymerized ABS inner tie-layer multi-layer articles of the present application will exhibit fewer inclusion defects than formed articles produced with PC-emulsion ABS inner tie-layers. For example, on an average, greater than or equal to 33% of articles produced with a PC-emulsion ABS inner tie-layers will have surface defects arising from tie-layer inclusion defects greater than or equal to 0.2 mm in diameter. With regard to the PC-bulk polymerized ABS inner tie-layer multi-layer articles, specifically, less than or equal to 20% of the formed articles will have surface defects arising from tie-layer inclusion defects greater than or equal to 0.2 mm in diameter, more specifically less than or equal to 10% of the formed articles will have surface defects arising from tie-layer inclusion defects greater than or equal to 0.2 mm in diameter, even more specifically, less than or equal to 5% of the formed articles will have surface defects arising from tie-layer inclusion defects greater than or equal to 0.2 mm in diameter, yet more specifically, less than or equal to 2% of the formed articles will have surface defects arising from tie-layer inclusion defects greater than or equal to 0.2 mm in diameter.

The terms “first,” “second,” and the like, “primary,” “secondary,” and the like, as used herein do not denote any order, quantity, or importance, but rather are used to distinguish one element from another. The terms “a” and “an” do not denote a limitation of quantity, but rather denote the presence of at least one of the referenced item. “Optional” or “optionally” means that the subsequently described event or circumstance may or may not occur, and that the description includes instances where the event occurs and instances where it does not. Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

Unless defined otherwise, technical and scientific terms used herein have the same meaning as is commonly understood by one of skill in the art to which this invention belongs. The modifier “about” used in connection with a quantity is inclusive of the stated value and has the meaning dictated by the context (e.g., includes the degree of error associated with measurement of the particular quantity). The endpoints of all ranges directed to the same component or property are inclusive of the endpoint and independently combinable optional: [(e.g., ranges of “up to about 25 wt. %, or, more specifically, about 5 wt. % to about 20 wt. %,” is inclusive of the endpoints and all intermediate values of the ranges of “about 5 wt. % to about 25 wt. %,” etc.). The suffix “(s)” as used herein is intended to include both the singular and the plural of the term that it modifies, thereby including one or more of that term (e.g., the colorant(s) includes one or more colorants).

As used herein, “combination” is inclusive of blends, mixtures, alloys, reaction products, and the like. Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. A formable thermoplastic multi-layer article comprising:
an outer layer comprising a polymer comprising resorcinol arylate polyester chain members;
a middle layer comprising a thermoplastic polymer;
an inner tie-layer comprising a thermoplastic polymer comprising a carbonate polymer and bulk polymerized acrylonitrile-butadiene-styrene;
the middle layer being between the outer layer and the inner tie-layer and being in contact with both the outer layer and the inner tie-layer.

2. The multi-layer article of claim 1, wherein the inner tie-layer further comprises a styrene acrylonitrile copolymer (SAN).

3. The multi-layer article of claim 1, wherein the inner tie-layer comprises about 25 to about 80 weight % of polycarbonate based on the total weight of the inner tie-layer.

4. The multi-layer article of claim 3, wherein the inner tie-layer comprises about 10 to about 35 weight % of the bulk polymerized acrylonitrile-butadiene-styrene, the weight % being based on the total weight of the inner tie-layer.

5. The multi-layer article of claim 4, wherein the inner tie-layer comprises about 10 to about 35 weight % of the bulk polymerized acrylonitrile-butadiene-styrene, and further comprises about 0 to about 30 weight % of a rigid styrenic copolymer, based on the total weight of the inner tie-layer.

6. The multi-layer article of claim 5, wherein the styrenic copolymer is a styrene acrylonitrile copolymer (SAN).

7. The multi-layer article of claim 1, wherein the inner tie-layer comprises a thermoplastic polymer having a melt flow index of about 3 to about 30 cm³/10 min (at 260° C./5 kg).

8. The multi-layer article of claim 1, formed by co-extrusion of the inner tie-layer, middle layer, and outer layer.

9. The multi-layer article of claim 1, further comprising a substrate bonded to the inner tie-layer.

10. The multi-layer article of claim 1, wherein adhesion between the middle layer and the inner tie-layer as measured by a 90° peel test is greater than or equal to 701 Newtons per meter.

11. The multi-layer article of claim 1, wherein adhesion between the middle layer and the inner tie-layer as measured by a 90° peel test is greater than or equal to 1051 Newtons per meter.

12. The multi-layer article of claim 1, wherein adhesion between the middle layer and the inner tie-layer as measured by a 90° peel test is greater than or equal to 1401 Newtons per meter.

13. The multi-layer article of claim 1, wherein less than or equal to 20% of the articles have inner tie-layer inclusion defects greater than or equal to 0.2 mm in diameter.

14. The multi-layer article of claim 1, wherein less than or equal to 10% of the articles have inner tie-layer inclusion defects greater than or equal to 0.2 mm in diameter.

15. The multi-layer article of claim 1, wherein less than or equal to 5% of the articles have inner tie-layer inclusion defects greater than or equal to 0.2 mm in diameter.

16. The multi-layer article of claim 1, wherein less than or equal to 2% of the articles have inner tie-layer inclusion defects greater than or equal to 0.2 mm in diameter.

17. A thermoformed article comprising:
an outer layer comprising a polymer comprising resorcinol arylate polyester chain members;
a middle layer comprising a thermoplastic polymer;
an inner tie-layer comprising a thermoplastic polymer comprising a carbonate polymer and bulk polymerized acrylonitrile butadiene styrene;
the middle layer being juxtaposed between the outer layer and the inner tie-layer and being in continuous contact with both the outer layer and the inner tie-layer;
wherein less than or equal to 20% of greater than or equal to 100 of the formed articles have surface defects arising from tie-layer inclusion defects greater than or equal to 0.2 mm in diameter.

18. The formed article of claim 17, wherein less than or equal to 10% of greater than or equal to 100 of the formed articles have surface defects arising from tie-layer inclusion defects greater than or equal to 0.2 mm in diameter.

19. The formed article of claim 17, wherein less than or equal to 5% of greater than or equal to 100 of the formed articles have surface defects arising from tie-layer inclusion defects greater than or equal to 0.2 mm in diameter.

20. The formed article of claim 17, wherein less than or equal to 2% of greater than or equal to 100 of the formed articles have surface defects arising from tie-layer inclusion defects greater than or equal to 0.2 mm in diameter.

21. A method of making a multi-layer article, comprising:
coextruding:
an outer layer comprising a polymer comprising resorcinol arylate polyester chain members;
a middle layer comprising a thermoplastic polymer; and
an inner tie-layer comprising a thermoplastic polymer comprising a carbonate polymer and a bulk polymerized acrylonitrile-butadiene-styrene;
the middle layer being between the outer layer and the inner tie-layer and being in contact with both the outer layer and the inner tie-layer.

22. A method of making an article, comprising:
placing a multi-layer article into a mold;
forming a cavity behind the multi-layer article, wherein the multi-layer article comprises:
an outer layer comprising a polymer comprising resorcinol arylate polyester chain members;
a middle layer comprising a thermoplastic polymer; and
an inner tie-layer comprising a thermoplastic polymer comprising a carbonate polymer and a bulk polymerized acrylonitrile-butadiene-styrene;
the middle layer being between the outer layer and the inner tie-layer and being in contact with the both the outer layer and the inner tie-layer;
placing a substrate into the cavity; and
bonding the inner tie-layer to the substrate.

23. (canceled)

24. The multilayer film of claim 1, wherein the bulk polymerized acrylonitrile-butadiene-styrene is present in the inner tie-layer in an amount of greater than or equal to 50 wt %, wherein the weight percent is based upon a total weight of the ABS in the inner tie-layer.
